(19) United States
(12) Patent Application Publication
(10) Pub. No.: US 2026/0339624 A1
(43) Pub. Date: Oct. 29, 2026

(54) GENERATION OF EXECUTABLE INSTRUCTIONS USING CODE LANGUAGE MODEL

(71) Applicant: International Business Machines Corporation, Armonk, NY (US)

(72) Inventors: Saki Takano, Tokyo (JP); Takumi Yanagawa, Tokyo (JP); HIROKUNI KITAHARA, Tokyo (JP); YUJI WATANABE, Tokyo (JP)

(21) Appl. No.: 19/191,205

(22) Filed: Apr. 28, 2025

(51) Int. Cl. G06F 8/35; G06Q 30/018

(52) U.S. Cl. CPC G06F 8/35; G06Q 30/018

(57) ABSTRACT

Generation of executable instructions based on a code language model includes receiving a first prompt associated with an operational issue of a specific domain. Method data associated with the first prompt is retrieved from a knowledge base. A set of action specifications is converted into a set of method signatures. A set of method descriptions associated with the set of method signatures is retrieved. A second prompt which includes first prompt, set of method signatures, and set of method descriptions is generated. An accuracy score of the second prompt is greater than an accuracy score of the first prompt. The code language model is applied to the second prompt. A first set of executable instructions is generated based on the application of the code language model to the second prompt. Execution of at least a subset of executable instructions of the first set of executable instructions is controlled.

### BACKGROUND

The disclosure relates to Generative Artificial Intelligence (GenAI) and more particularly, to Natural Language Processing (NLP).

In current era of automation and Artificial Intelligence (AI), the NLP has emerged as a key component for improving user engagement and streamlining complex processes. With increased reliance on the NLP, businesses, and organizations aim to professionally process natural language queries to generate meaningful insights or perform operations seamlessly. This shift has increased the demand for intelligent systems that can transform natural language queries into structured, actionable outputs. The capacity to efficiently execute the natural language queries is vital in various fields, including compliance management, software automation, and data analysis.

### SUMMARY

In various embodiments of the disclosure, the computer-implemented method for generation of a set of executable instructions based on a code language model is described. The computer-implemented method includes receiving, by a computer, a first prompt associated with an operational issue of a specific domain. The first prompt includes a set of action specifications. The computer-implemented method further includes retrieving, by the computer, method data associated with the first prompt. The method data is retrieved from a knowledge base based on the reception of the first prompt. The computer-implemented method further includes converting, by the computer, the set of action specifications into a set of method signatures based on the retrieval of the method data. The computer-implemented method further includes retrieving, by the computer, a set of method descriptions associated with the set of method signatures based on the conversion. The method data includes the set of method descriptions. The computer-implemented method further includes generating, by the computer, a second prompt including the first prompt, the set of method signatures, and the method descriptions. An accuracy score of the second prompt is greater than an accuracy score of the first prompt. The computer-implemented method further includes applying, by the computer, a code language model to the second prompt. The computer-implemented method further includes generating, by the computer, a first set of executable instructions for a resolution of the operational issue. The first set of executable instructions is generated based on the application of the code language model to the second prompt. The computer-implemented method further includes controlling, by the computer, an execution of at least a subset of executable instructions of the first set of executable instructions.

In various embodiments of the disclosure, a computer system for generation of a set of executable instructions based on a code language model is described.

In various embodiments of the disclosure, a computer-program product for generation of a set of executable instructions based on a code language model is described.

Additional technical features and benefits are realized through the processes of the disclosure. Embodiments and aspects of the disclosure are described in detail herein and are considered a part of the claimed subject matter. For a better understanding, refer to the detailed description and the drawings.

### BRIEF DESCRIPTION OF THE DRAWINGS

The following description will provide details of preferred embodiments with reference to the following figures wherein:

FIG. 1 is a diagram that illustrates a computing environment for generation of a set of executable instructions based on a code language model, in accordance with various embodiments of the disclosure;

FIG. 2 is a diagram that illustrates a network environment for the generation of the set of executable instructions based on the code language model, in accordance with various embodiments of the disclosure;

FIG. 3A and FIG. 3B collectively is a block diagram that illustrates one or more operations for the generation of the set of executable instructions based on the code language model, in accordance with various embodiments of the disclosure;

FIG. 4 is a diagram that illustrates exemplary operations for the generation of the set of executable instructions based on the code language model, in accordance with various embodiments of the disclosure;

FIG. 5A is a diagram that illustrates an exemplary first user interface for performing the set of executable instructions generation based on the code language model, in accordance with various embodiments of the disclosure;

FIG. 5B is a diagram that illustrates an exemplary second user interface for performing the set of executable instructions generation basefd on the code language model, in accordance with various embodiments of the disclosure; and

FIG. 6A and FIG. 6B collectively illustrates a flowchart of an exemplary method for the generation of the set of executable instructions based on the code language model, in accordance with various embodiments of the disclosure.

### DETAILED DESCRIPTION

In the contemporary landscape of automation and intelligent systems, the ability to efficiently read natural language inputs and translate the natural language inputs into a set of executable instructions is becoming increasingly vital. This ability is vital for software development, compliance management, and data analysis. Organizations attempt to streamline workflows by utilizing powerful computational models that can dynamically adapt to diverse and changing user requirements. Traditional methods to transform natural language prompts into actionable outputs frequently rely on established rules or static templates. These methods are primarily limited in flexibility and fail to account for variations of human language, especially when dealing with complex prompts or domain-specific terminologies. As a result, users typically face inefficiencies, such as misinterpretations, delays, or incomplete task resolution.

Recent advancements in language models have provided new opportunities to overcome these challenges. By leveraging large-scale models that can comprehend and generate outputs that are applicable to handle the varying user intents, these models can now process natural language inputs with advanced accuracy and adaptability. The large-scale models, trained on vast datasets, enable the generation of structured instructions or code with minimal user intervention. Unlike traditional methods, such systems can dynamically adjust to varying user intents, making the systems particularly effective in scenarios involving ambiguous or complex queries.

The present disclosure provides a method for generating a set of executable instructions using code language models such as large language models (LLMs), such that the method offers several advantages over traditional methods by incorporating advanced language models. The disclosed system improves computational efficiency by automating the conversion of user prompts into a set of executable instructions. The disclosed system dynamically parses, analyzes, and structures natural language inputs, reducing computational overhead and fine-tuning system performance. By minimizing dependency on manual intervention, the system enhances processing accuracy, reducing errors caused by human misinterpretation and improving the overall efficiency of instruction execution. Furthermore, the disclosed system eliminates the need for extensive training or technical expertise, empowering non-technical users to interact with the system using natural language. This democratization of the set of executable instructions enhances collaboration between technical and non-technical teams, fostering a more agile and inclusive decision-making environment.

Furthermore, the disclosed system incorporates an adaptive processing mechanism that controls the execution of the set of executable instructions iteratively. The disclosed system utilizes a feedback-based execution control module that ensures incremental refinement of the set of executable instructions based on contextual corrections. This approach significantly enhances instruction accuracy and consistency, allowing for real-time adaptation to complex computing tasks. The disclosed system dynamically adapts to varied user intents and business logic, improving its ability to handle a broad spectrum of computational tasks.

The disclosed system incorporates a self-learning mechanism to enhance model training efficiency. By analyzing execution feedback loops, the system autonomously refines prompt classifications and adjusts the executable instructions generation process. The disclosed system implements continuous adaptive learning, allowing for real-time performance enhancement. This enhances scalability, ensuring that the system remains efficient across diverse operational environments.

The disclosed system further provides an interactive terminal (or a user-friendly interface) for communication between the users and the generation process of the set of executable instructions. The disclosed system provides information to the users through which the users can identify errors, verify the set of executable instructions generated by the disclosed system and manually enter the correction in case they find some inaccuracies in the generated set of executable instructions.

The disclosed system also provides significant improvements in resource fine-tuning by minimizing processing time and computational load by streamlining query analysis and execution workflows. As a result, the system fine-tuned CPU and memory utilization, reducing overall infrastructure costs associated with large-scale executable instruction execution. Additionally, the system minimizes data redundancy by ensuring that only a fine-tuned, validated set of executable instructions is executed, further improving operational efficiency.

In various embodiments of the disclosure, the computer-implemented method for generation of a set of executable instructions based on a code language model is described. The computer-implemented method includes receiving, by a computer, a first prompt associated with an operational issue of a specific domain. The first prompt includes a set of action specifications. The computer-implemented method further includes retrieving, by the computer, method data associated with the first prompt. The method data is retrieved from a knowledge base based on the reception of the first prompt. The computer-implemented method further includes converting, by the computer, the set of action specifications into a set of method signatures based on the retrieval of the method data. The computer-implemented method further includes retrieving, by the computer, a set of method descriptions associated with the set of method signatures based on the conversion. The method data includes the set of method descriptions. The computer-implemented method further includes generating, by the computer, a second prompt including the first prompt, the set of method signatures, and the method descriptions. An accuracy score of the second prompt is greater than an accuracy score of the first prompt. The computer-implemented method further includes applying, by the computer, a code language model to the second prompt. The computer-implemented method further includes generating, by the computer, a first set of executable instructions for a resolution of the operational issue. The first set of executable instructions is generated based on the application of the code language model to the second prompt. The computer-implemented method further includes controlling, by the computer, an execution of at least a subset of executable instructions of the first set of executable instructions.

In various embodiments of the disclosure, the computer-implemented method further includes receiving, by the computer, first output data based on the controlling of the execution of at least the subset of executable instructions. The computer-implemented method further includes rendering, by the computer, the first output data.

In various embodiments of the disclosure, the computer-implemented method further includes receiving, by the computer, feedback data associated with the first output data and the first set of executable instructions. The feedback data is received based on the controlling of the execution of at least the subset of executable instructions. The computer-implemented method further includes modifying, by the computer, the second prompt based on the feedback data.

In various embodiments of the disclosure, the computer-implemented method further includes applying, by the computer, the code language model to the modified second prompt. The computer-implemented method further includes generating, by the computer, a second set of executable instructions for the resolution of the operational issue. The second set of executable instructions is generated based on the application of the code language model to the modified second prompt. The computer-implemented method further includes controlling, by the computer, the execution of at least a subset of executable instructions of the second set of executable instructions. The execution of at least the subset of executable instructions of the second set of executable instructions resolves the operational issue of the specific domain.

In various embodiments of the disclosure, the computer-implemented method further includes receiving, by the computer, second output data based on the controlling of the execution of at least the subset of executable instructions of the second set of executable instructions. The computer-implemented method further includes rendering, by the computer, the second output data.

In various embodiments of the disclosure, the computer-implemented method further includes analyzing, by the computer, the first prompt. The computer-implemented method further includes determining, by the computer, a programming language of a set of programming languages based on the analysis of the first prompt. The first prompt includes the programming language. The computer-implemented method further includes generating, by the computer, the first set of executable instructions based on the determination of the programming language and the second prompt. The first set of executable instructions is generated in the determined programming language.

In various embodiments of the disclosure, the knowledge base is associated with at least one programming language of the set of programming languages, or contextual data associated with the operational issue.

In various embodiments of the disclosure, the operational issue corresponds to a compliance problem. The compliance problem is associated with an adherence to at least one of regulatory guidelines, governmental regulations, or organization-specific regulations.

In various embodiments of the disclosure, each method description of the set of method descriptions is associated with a corresponding method signature of the set of method signatures. Each method description is in a textual format.

In various embodiments of the disclosure, a computer system for generation of a set of executable instructions based on a code language model is described. The computer system includes a processor set, a computer-readable storage media, and program instructions that are stored on the one or more computer-readable storage media, the program instructions are executable by the processor set to cause the processor set to receive a first prompt associated with an operation issue of a specific domain. The first prompt includes a set of action specifications. The program instructions further cause the processor set to retrieve method data associated with the first prompt. The method data is retrieved from a knowledge base based on the reception of the first prompt. The program instructions further cause the processor set to convert the set of action specifications into a set of method signatures based on the retrieval of the method data. The program instructions further cause the processor set to retrieve a set of method descriptions associated with the set of method signatures based on the conversion. The method data includes the set of method descriptions. The program instructions further cause the processor set to generate a second prompt. The second prompt includes the first prompt, the set of method signatures, and the set of method descriptions. An accuracy score of the second prompt is greater than the accuracy score of the first prompt. The program instructions further cause the processor set to apply a code language model to the second prompt. The program instructions further cause the processor set to generate a first set of instructions for a resolution of the operational issue. The first set of instructions is generated based on the application of the code language model to the second prompt. The program instructions further cause the processor set to control an execution of at least a subset of executable instructions of the first set of executable instructions. The program instructions further cause the processor set to receive first output data based on the control of the execution of at least the subset of executable instructions of the first set of executable instructions.

In various embodiments of the disclosure, the program instructions further cause the processor set to receive first output data based on the control of the execution of at least the subset of executable instructions. In various embodiments of the disclosure, the program instructions further cause the processor set to render the first output data.

In various embodiments of the disclosure, the program instructions further cause the processor set to receive feedback data associated with the first output data and the first set of executable instructions. The feedback data is received based on the control of execution of at least the subset of executable instructions. The program instructions further cause the processor set to modify the second prompt based on the feedback data.

In various embodiments of the disclosure, the program instructions further cause the processor set to analyze the first prompt. The program instructions further cause the processor set to determine a programming language of a set of programming languages based on the analysis of the first prompt. The first prompt includes the programming language. The program instructions further cause the processor set to generate the first set of executable instructions based on the determination of the programming language and the second prompt. The first set of executable instructions is generated in the determined programming language.

In various embodiments of the disclosure, the knowledge base is associated with at least one programming language of the set of programming languages, or contextual data associated with the operational issue.

In various embodiments of the disclosure, the operational issue corresponds to a compliance problem. The compliance problem is associated with an adherence to at least one of regulatory guidelines, governmental regulations, or organization-specific regulations.

In various embodiments of the disclosure, each method description of the set of method descriptions is associated with a corresponding method signature of the set of method signatures and each method description is in a textual format.

In various embodiments of the disclosure, a computer program-product for generation of executable instructions based on a code language model is described. The computer program product includes a computer-readable storage medium having program instructions stored on the computer-readable storage media to perform operations. The operations include receiving a first prompt associated with an operational issue of a specific domain. The operations further include retrieving method data associated with the first prompt. The method data is retrieved from a knowledge base based on the reception of the first prompt. The operations further include converting the set of action specifications into a set of method signatures based on the retrieval of the method data. The operations further include retrieving a set of method descriptions associated with the set of method signatures based on the conversion. The method data includes the set of method descriptions. The operations further include generating a second prompt including the first prompt, the set of method signatures, and the set of method descriptions. An accuracy score of the second prompt is greater than an accuracy score of the first prompt. The operations further include applying a code language model to the second prompt. The operations further include generating a set of executable instructions for a resolution of the operational issue. The first set of executable instructions is generated based on the application of the code language model to the second prompt. The operations further include controlling an execution of at least a subset of executable instructions of the first set of executable instructions.

In various embodiments of the disclosure, the operations include receiving first output data based on the controlling of the execution of at least the subset of executable instructions. In various embodiments of the disclosure, the operations further include rendering the first output data.

In various embodiments of the disclosure, the operations include receiving feedback data associated with the first output data and the first set of executable instructions. The feedback data is received based on the controlling of the execution of at least the subset of executable instructions of the first set of executable instructions. In various embodiments of the disclosure, the operations further include modifying the second prompt based on the feedback data.

In various embodiments of the disclosure, the operations include analyzing the first prompt. In various embodiments of the disclosure, the operations include determining a programming language based on the analysis of the first prompt. The first prompt includes the programming language. In various embodiments of the disclosure, the operations include generating the set of executable instructions based on the determination of the programming language and the second prompt. The first set of executable instructions is generated in the determined programming language.

Various aspects of the present disclosure are described by narrative text, flowcharts, block diagrams of computer systems, and/or block diagrams of the machine logic included in computer program product (CPP) embodiments. With respect to any flowcharts, depending upon the technology involved, the operations may be performed in a different order than what is shown in each flowchart. For example, again depending upon the technology involved, two operations shown in successive flowchart blocks may be performed in reverse order, as a single integrated operation, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that may retain and store instructions for use by a computer processor. Without limitation, the computer-readable storage media is an electronic storage media, a magnetic storage media, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or freely propagating electromagnetic waves, electromagnetic waves propagating through a waveguide, light pulses passing through a fiber optic cable, electrical signals communicated through a wire, and/or transmission media. As will be understood by those of skill in the art, data is typically moved at some occasional points in time during normal operations of a storage device, such as during access, de-fragmentation, or garbage collection, but this does not render the storage device as transitory because the data is not transitory while the data is stored.

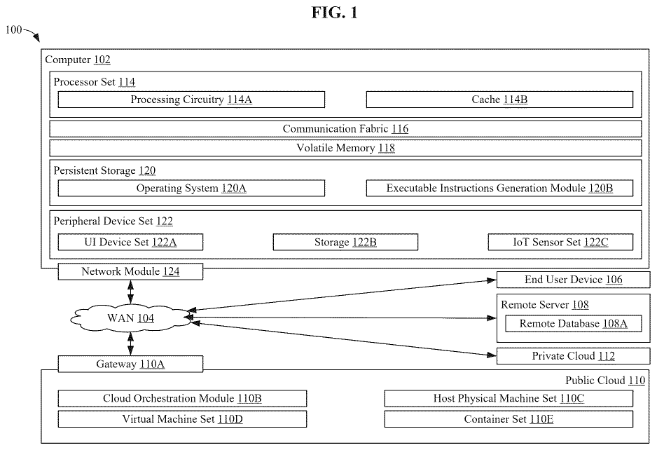

FIG. 1 is a diagram that illustrates a computing environment for generation of set of executable instructions based on the code language model, in accordance with an embodiment of the disclosure. With reference to FIG. 1, there is shown a computing environment 100 that contains an example of an environment for the execution of at least some of the computer code involved in performing the disclosed methods, such as an executable instructions generation module 120B. In addition to the executable instructions generation module 120B, computing environment 100 includes, for example, a computer 102, a wide area network (WAN) 104, an end user device (EUD) 106, a remote server 108, a public cloud 110, and a private cloud 112. In this embodiment of the disclosure, the computer 102 includes a processor set 114 (including a processing circuitry 114A and a cache 114B), a communication fabric 116, a volatile memory 118, a persistent storage 120 (including an operating system 120A and the executable instructions generation module 120B, as identified above), a peripheral device set 122 (including a user interface (UI) device set 122A, a storage 122B, and an Internet of Things (IoT) sensor set 122C), and a network module 124. The remote server 108 includes a remote database 108A. The public cloud 110 includes a gateway 110A, a cloud orchestration module 110B, a host physical machine set 110C, a virtual machine set 110D, and a container set 110E.

The computer 102 may take the form of a desktop computer, a laptop computer, a tablet computer, a smartphone, a smartwatch or a wearable computer, a mainframe computer, a quantum computer, or any various forms of a computer or a mobile device now known or to be developed in the future that can run a program, access a network or query a database, such as the remote database 108A. As is well understood in the art of computer technology, and depending upon the technology, the performance of a computer-implemented method may be distributed among multiple computers and/or between multiple locations. In this presentation of the computing environment 100, detailed discussion is focused on a single computer, specifically the computer 102, to keep the presentation as simple as possible. The computer 102 may be located in a cloud, even though not shown in a cloud in FIG. 1.

The processor set 114 includes one, or more, computer processors of any type now known or to be developed in the future. The processing circuitry 114A may be distributed over multiple packages, for example, multiple, coordinated integrated circuit chips. The processing circuitry 114A may implement multiple processor threads and/or multiple processor cores. The cache 114B is a memory that is located in the processor chip package(s) and is typically used for data or code that should be available for rapid access by the threads or cores running on the processor set 114. Cache memories are typically organized into multiple levels depending upon relative proximity to the processing circuitry 114A. Alternatively, some, or all, of the cache 114B for the processor set 114 may be located “off-chip.” In some computing environments, the processor set 114 may be designed for working with qubits and performing quantum computing.

Computer readable program instructions are typically loaded onto the computer 102 to cause a series of operations to be performed by the processor set 114 of the computer 102 and thereby effect a computer-implemented method, such that the instructions thus executed will instantiate the methods specified in flowcharts and/or narrative descriptions of computer-implemented methods included in this document (collectively referred to as “the disclosed methods”). These computer-readable program instructions are stored in various types of computer-readable storage media, such as the cache 114B and the various storage media discussed below. The program instructions, and associated data, are accessed by the processor set 114 to control and direct the performance of the disclosed methods. In computing environment 100, at least some of the instructions for performing the disclosed methods may be stored in the dynamic modification of the executable instructions generation module 120B in persistent storage 120.

The communication fabric 116 is the signal conduction path that allows the various components of computer 102 to communicate with each other. Typically, this fabric is made of switches and electrically conductive paths, such as the switches and electrically conductive paths that make up buses, bridges, physical input/output ports, and the like. Various types of signal communication paths are used, such as fiber optic communication paths and/or wireless communication paths.

The volatile memory 118 is any type of volatile memory now known or to be developed in the future. Examples include dynamic type random access memory (RAM) or static type RAM. Typically, the volatile memory 118 is characterized by random access, but this is not needed unless affirmatively indicated. In the computer 102, the volatile memory 118 is located in a single package and is internal to the computer 102, but alternatively or additionally, the volatile memory 118 may be distributed over multiple packages and/or located externally with respect to the computer 102.

The persistent storage 120 is any form of non-volatile storage for computers that is now known or to be developed in the future. The non-volatility of this storage means that the stored data is maintained regardless of whether power is being supplied to the computer 102 and/or directly to the persistent storage 120. The persistent storage 120 is a read-only memory (ROM), but typically at least a portion of the persistent storage 120 allows the writing of data, deletion of data, and re-writing of data. Some familiar forms of the persistent storage 120 include magnetic disks and solid-state storage devices. The operating system 120A may take several forms, such as various known proprietary operating systems or open-source Portable Operating System Interface-type operating systems that employ a kernel. The code included in the executable instructions generation module 120B typically includes at least some of the computer code involved in performing the disclosed methods.

The peripheral device set 122 includes the set of peripheral devices of computer 102. Data communication connections between the peripheral devices and the various components of the computer 102 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments of the disclosure, the UI device set 122A includes components such as a display screen, speaker, microphone, wearable devices (such as goggles and smartwatches), keyboard, mouse, printer, touchpad, game controllers, and haptic devices. The storage 122B is external storage, such as an external hard drive, or insertable storage, such as an SD card. The storage 122B is persistent and/or volatile. In some embodiments of the disclosure, the storage 122B may take the form of a quantum computing storage device for storing data in the form of qubits. In embodiments of the disclosure where the computer 102 is needed to have a large amount of storage (for example, where the computer 102 locally stores and manages a large database) then this storage may be provided by peripheral storage devices designed for storing very large amounts of data, such as a storage area network (SAN) that is shared by multiple, geographically distributed computers. The IoT sensor set 122C is made up of sensors that can be used in Internet of Things applications. For example, a first sensor may be a thermometer, and a second sensor may be a motion detector.

The network module 124 is the collection of computer software, hardware, and firmware that allows the computer 102 to communicate with various computers through the WAN 104. The network module 124 may include hardware, such as modems or Wi-Fi signal transceivers, software for packetizing and/or de-packetizing data for communication network transmission, and/or web browser software for communicating data over the internet. In some embodiments of the disclosure, network control functions, and network forwarding functions of the network module 124 are performed on the same physical hardware device. In various embodiments of the disclosure (for example, embodiments that utilize software-defined networking (SDN)), the control functions and the forwarding functions of the network module 124 are performed on physically separate devices, such that the control functions manage several different network hardware devices. Computer-readable program instructions for performing the disclosed methods can typically be downloaded to the computer 102 from an external computer or external storage device through a network adapter card or network interface included in the network module 124.

The WAN 104 is any wide area network (for example, the internet) for communicating computer data over non-local distances by any technology for communicating computer data, now known or to be developed in the future. In some embodiments of the disclosure, the WAN 104 may be replaced and/or supplemented by local area networks (LANs) designed to communicate data between devices located in a local area, such as a Wi-Fi network. The WAN 104 and/or LANs typically include computer hardware such as copper transmission cables, optical transmission fibers, wireless transmission, routers, firewalls, switches, gateway computers, and edge servers.

The EUD 106 is any computer system that is used and controlled by an end user (for example, a customer of an enterprise that operates the computer 102) and may take any of the forms discussed above in connection with the computer 102. The EUD 106 typically receives helpful and useful data from the operations of the computer 102. For example, in a hypothetical case where the computer 102 is designed to provide a recommendation to an end user, this recommendation would typically be communicated from the network module 124 of the computer 102 through WAN 104 to EUD 106. In this way, the EUD 106 can display, or otherwise present recommendations to an end user. In some embodiments of the disclosure, the EUD 106 may be a client device, such as a mainframe computer, desktop computer, and so on.

The remote server 108 is any computer system that serves at least some data and/or functionality to the computer 102. The remote server 108 may be controlled and used by the same entity that operates the computer 102. The remote server 108 represents the machine(s) that collect and store helpful and useful data for use by various computers, such as the computer 102. For example, in a hypothetical case where the computer 102 is designed and programmed to provide a recommendation based on historical data, then this historical data may be provided to the computer 102 from the remote database 108A of the remote server 108.

The public cloud 110 is any computer system available for use by multiple entities that provides on-demand availability of computer system resources and/or various computer capabilities, especially data storage (cloud storage) and computing power, without direct active management by the user. Cloud computing typically leverages the sharing of resources to achieve coherence and economies of scale. The direct and active management of the computing resources of the public cloud 110 is performed by the computer hardware and/or software of the cloud orchestration module 110B. The computing resources provided by the public cloud 110 are typically implemented by virtual computing environments that run on various computers making up the computers of the host physical machine set 110C, which is the universe of physical computers in and/or available to the public cloud 110. The virtual computing environments (VCEs) typically take the form of virtual machines from the virtual machine set 110D and/or containers from the container set 110E. It is understood that these VCEs may be stored as images and may be transferred among and between the various physical machine hosts, either as images or after the instantiation of the VCE. The cloud orchestration module 110B manages the transfer and storage of images, deploys new instantiations of VCEs, and manages active instantiations of VCE deployments. The gateway 110A is the collection of computer software, hardware, and firmware that allows public cloud 110 to communicate through the WAN 104.

Some further explanation of virtualized computing environments (VCEs) will now be provided. VCEs can be stored as “images”. A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running within. A computer program running on an ordinary operating system can utilize the resources of that computer, such as connected devices, files and folders, network shares, CPU power, and quantifiable hardware capabilities. However, programs running inside a container can only use the contents of the container and devices assigned to the container, a feature which is known as containerization.

The private cloud 112 is similar to public cloud 110, except that the computing resources are only available for use by a single enterprise. While the private cloud 112 is shown as being in communication with the WAN 104, in various embodiments of the disclosure, a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment of the disclosure, the public cloud 110 and the private cloud 112 are both part of a larger hybrid cloud.

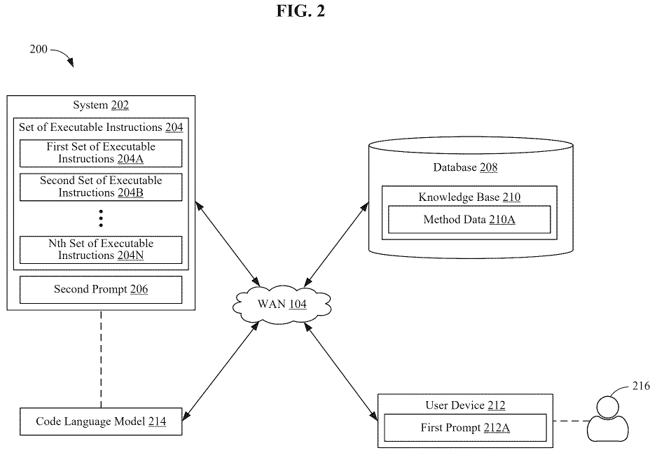

FIG. 2 is a diagram that illustrates a network environment 200 for the generation of the set of executable instructions based on the code language model, in accordance with various embodiments of the disclosure. FIG. 2 is explained in conjunction with elements from FIG. 1. With reference to FIG. 2, there is shown a diagram of a network environment 200. The network environment 200 includes a computer system 202 (hereinafter referred to as a system 202). The system 202 includes a set of executable instructions 204 and a second prompt 206. The set of executable instructions 204 further includes a first set of executable instructions 204A, a second set of executable instructions 204B up to an nth set of executable instructions 204N. The network environment 200 further includes a database 208. The database 208 further includes a knowledge base 210. The knowledge base further includes method data 210A. The network environment further includes a code language model 214. The network environment 200 further includes a user device 212. The user device 212 further includes a first prompt 212A. The user device 212 is associated with a user 216. The network environment 200 further includes the WAN 104 of FIG. 1. In an example, the system 202 is an exemplary embodiment of the computer 102 in FIG. 1.

The system 202 may include suitable logic, circuitry, interfaces, and/or code that may be configured to receive the first prompt 212A associated with an operational issue of a specific domain. The first prompt 212A is received from the user device 212 and the first prompt 212A includes a set of action specifications. The system 202 is further configured to retrieve method data 210A from the knowledge base 210 based on the reception of the first prompt 212A. The system 202 is further configured to convert a set of action specifications into a set of method signatures. The system 202 is further configured to retrieve a set of method descriptions. The system 202 is further configured to generate a second prompt 206 which includes the first prompt 212A, the set of method signatures and, the set of method descriptions. The system is further configured to compute an accuracy score of the first prompt 212A and an accuracy score of the second prompt 206. The system 202 is further configured to apply the code language model 214 to the second prompt 206. The system 202 is further configured to generate the first set of executable instructions 204A based on the application of the code language model 214 to the second prompt 206. The system 202 is further configured to generate the second set of executable instructions 204B based on the application of the code language model 214 to the modified second prompt. Similarly, the system 202 is configured to generate the next set of executable instructions up to the nth set of executable instructions 204N until each instruction of the set of executable instructions 204 is executed. The system 202 is further configured to control an execution of at least a subset of executable instructions of the first set of executable instructions 204A associated with the first prompt 212A.

Examples of the system 202 include, but are not limited to, a server, a computing device, a virtual computing device, a mainframe machine, a computer workstation, a smartphone, a cellular phone, a mobile phone, a gaming device, or a consumer electronic (CE) device. In an example embodiment of the disclosure, the system 202 may be embodied as a cloud-based service, a cloud-based application, a cloud-based platform, a remote server-based service, a remote server-based application, a remote server-based platform, or a virtual computing system.

In an embodiment, the database 208 is a structured collection of data that enables efficient storage, retrieval, and management of information, often organized in a way that provides easy access and manipulation. In an embodiment, the database 208 maybe present within the system 202. In an alternate embodiment, the database 208 may be present outside the system 202. The database 208 is set up to promote the manipulation and retrieval of data quickly using a Database Management System (DBMS). In an embodiment, the system 202 may utilize the database 208 to store and manage data associated with the generation of the set of executable instructions 204. By way of example, and not by limitation, the database 208 includes a repository that integrates various types of information vital for the generation of the set of executable instructions 204 Associated with the first prompt 212A. The database 208 is configured to store the knowledge base 210. The knowledge base 210 is associated with at least one programming language of a set of programming languages, or contextual data associated with the operational issue. The contextual data corresponds to one or more portions of information that a company collects, and stores to support its decision-making planning. The contextual data may include, but not limited to, financial data, customer data, operational data, legal and compliance data, audit results, and transaction logs. The knowledge base 210 further includes method data 210A. The method data includes a set of method signatures. In an embodiment, the system 202 is configured to store the set of executable instructions 204 in database 208. In an example, the database 208 stores various versions of the set of executable instructions 204, allowing the system 202 to learn from user interactions and improve its understanding of user's intent over time and enhancing the accuracy of the generated set of executable instructions 204.

The user device 212 includes suitable logic, circuitry, and/or interfaces that are configured to execute one or more tasks within the network environment 200. The user device 212 performs one or more tasks such as receiving data, processing the data, and transmitting the data. Although in FIG. 2, the system 202 is shown as a separate entity from the user device 212, the disclosure is not so limited. Accordingly, in some embodiments, the system 202 may be shown integrated within the user device 212, without deviation from the scope of the disclosure.

In an embodiment of the disclosure, the system 202 receives the first prompt 212A from the user device 212. The first prompt 212A is associated with the operational issue provided by the user 216 associated with the user device 212. In an embodiment of the disclosure, the system 202 receives feedback associated with the generated set of executable instructions 204. In an embodiment of the disclosure, the system 202 renders the at least one subset of executable instructions of the set of executable instructions 204 on the user device 212. Examples of the user device 212 include one of but are not limited to, a smartphone, a cellular phone, a mobile phone, a consumer electronic (CE) device, an Internet of Things (IoT) device, a computing device, a mainframe machine, a server, a computer workstation, or the like.

In an embodiment, the code language model 214 may be used to generate the set of executable instructions 204 based on the first prompt 212A received from the user 216. The code language model 214 may be a portion of software that leverages natural language processing (NLP) and machine learning processes to understand, generate, and manipulate natural language. For example, the code language model 214 may correspond to a large language model (LLM) model that is specifically designed for tasks related to language understanding. Various characteristics of the LLM model may include, but are not limited to, natural language understanding, text generation, semantic understanding, transfer learning, multimodal abilities, continuous learning, and user interaction.

Further, the LLM may be a type of ML model specifically designed to understand, generate, and manipulate the natural language on a large scale. The LLM may leverage machine learning processes, particularly those based on deep learning architectures, to process and comprehend natural language. The LLM has gained prominence for the ability to perform a wide range of language-related tasks, including natural language understanding, text generation, translation, summarization, and more. Typically, the LLM may be characterized by a vast number of parameters, often ranging from tens of millions to billions. A large parameter count allows the LLM to capture complex language patterns and relationships during training.

For example, the LLM may be considered to be built on transformer architecture, however, this should not be construed as a limitation. For example, the transformer architecture effectively captures long-range dependencies and contextual information in language. Moreover, the transformer architecture may use attention mechanisms to weigh the significance of different parts of an input sequence (such as input of the second prompt 206 to the code language model 214). In addition, the LLM may employ bidirectional processing, allowing the models to consider context from both directions when analyzing a sequence of words. This bidirectional approach enhances understanding of the LLM relative to the context in which words appear. This enables the model to capture the meaning of words in different contexts.

Recently, the use of the LLM has increased manifold for a variety of language-related tasks, such as sentiment analysis, text classification, question answering, machine translation, summarization, and conversational agents. Due to the large number of parameters, training the LLM from scratch is a time-consuming and expensive process, and therefore, not preferable. To address the operational issue, pre-trained LLMs are used for generic tasks. For example, the LLM is typically pre-trained on extensive and diverse datasets containing a wide variety of text from the internet. Pre-training involves exposing the LLM to a broad range of language patterns, allowing the LLM to learn general linguistic features. However, for performing domain-specific tasks, adaptation of LLMs for the particular domain must be carried out. In one example, LLMs may leverage transfer learning where the model is pre-trained on a large corpus of data and then fine-tuned for specific tasks or domains. This approach enables the LLM to transfer the knowledge gained during the pre-training to various downstream applications.

Note that a base model in the LLM refers to a trained model that has been trained on a large corpus of data for a general natural language understanding and generation task. The trained model serves as a foundation for capturing broad linguistic patterns and knowledge from diverse sources. For example, in the context of pre-trained transformers, a base model is pre-trained on a massive dataset to predict the next word in a sequence, effectively learning grammar, context, and semantics from diverse language patterns.

For example, the base model contains a large number of parameters and exhibits a high level of language understanding, making the base model a powerful starting point for a variety of natural language processing tasks. While the base model is pre-trained on a large corpus of general language data, fine-tuning or adapting the base model for specific tasks or domains enhances the base model's performance and makes the base model more suitable for targeted applications.

Continuing further, an adapter refers to a smaller and task-specific module added to the base model to adapt the base model for a particular task or domain. The adapter includes a lightweight set of parameters that is trained on task-specific data while keeping the majority of the base model's parameters frozen. In particular, the adapter is used to fine-tune the base model for a specific downstream task without extensively modifying its pre-trained parameters. This approach is beneficial when computational resources or labeled task-specific data are limited.

In operation, the system 202 is configured to receive the first prompt 212A associated with the operational issue of the specific domain. The first prompt 212A is received from the user device 212 associated with the user 216. The first prompt 212A is transmitted from the user device 212, such as the smartphone, tablet, or computer, allowing users to engage with the system 202 in a conversational manner. In an embodiment, the first prompt 212A may include a query associated with a compliance task. For example, the compliance task may be associated with at least one of regulatory guidelines, governmental regulations, or organization-specific regulations. For instance, the user 216 might inquire about verifying adherence to regulations or standards like ensuring proper data handling. By understanding the first prompt 212A, the system 202 offers insightful information that makes decision-making easier.

Further, the system 202 is configured to retrieve the method data 210A associated with the first prompt 212A. The system 202 further converts the set of action specifications into a set of method signatures. The system 202 is further configured to retrieve a set of method descriptions. The method data 210A includes the set of method descriptions and each method description of the set of method descriptions is associated with the corresponding method signature of the set of method signatures. Each method signature of the set of method signatures corresponds to a function name, inputs, and outputs. The method data 210A further includes description data associated with each method signature of the set of method signatures. The description data is in a textual format. The method data 210A is retrieved from the knowledge base 210 based on the reception of the first prompt 212A. The knowledge base 210 is associated with the at least one of the programming language of the set of programming languages, or contextual data associated with the operational issue.

By way of example, and not by limitation, an example of the first prompt 212A is provided below:
“As an Agent, please write an ansible® playbook to do the following, given new rule with rule_id “ruleA” and description “A is enabled”
   collects Open Security Control Assessment Language (OSCAL) Assessment Results on Supply Chain Cybersecurity (SCC) eventually
   for that, runs a code on an appropriate verify tool (currently, only Ansible® is supported validation tool, report error if it is not Ansible®.)
   the code is generated using some functions with the rule description, similar example can be used to improve the code.
   the code should be posted to Version Control Platform as PR, the PR must be approved by SME. The code should not be run before Subject Matter Expert (SME's) approval.”

Further, the first prompt 212A includes the set of action specifications. An action specification of the set of action specifications is a high-level description of the operational issue, detailing what needs to be achieved. By way of example, and not by limitation, the first prompt 212A provided above may include, but not limited to, “verify validation tool”, “generate compliance code”, “post code to version control”, “enforce SME approval before execution”, and “execute code post-approval” as entities of the set of action specifications.

The system 202 is configured to retrieve method data 210A associated with the first prompt 212A and is retrieved from the knowledge base 210. The method data 210A further includes the set of method descriptions. By way of example, and not by limitation, the knowledge base 210 is linked to the one or more programming languages of the set of programming languages, such as python® or the ansible® playbook, or specific contextual data, like compliance-related information. The system 202 leverages the one or more programming languages of the set of programming languages or the contextual data for processing, automation, or decision-making tasks. The knowledge base 210 may include the contextual data such as historical compliance reports, audit results, and transaction logs, as well as regulatory guidelines and policies. As in the above provided first prompt 212A by the user 216 “Please write an Ansible® Playbook” so the system 202 might use ansible® to process the method data 210A. The system 202 is further configured to generate the set of executable instructions 204 in the ansible® playbook as stated in the first prompt 212A.

Further, the system 202 is configured to convert the set of action specifications into the set of method signatures by parsing the first prompt 212A. A method signature of the set of method signatures includes method name and input parameters. The system 202 utilizes a multi-process transformation approach where an action specification of the set of action specifications is provided as an input prompt and then the input prompt is analyzed to extract key compliance rules, constraints, and dependencies from the knowledge base 210. The multi-process transformation involves the natural language processing (NLP) processes, rule-based mapping, and modular decomposition to generate the set of method signatures. The generated set of method signatures define the execution logic vital to resolve the operational issue.

By way of example, and not by limitation, the system 202 processes the set of action specifications and converts the set of action specifications into the set of method signatures. With respect to the example of first prompt 212A, the method signature “void verifyValidationTool(String tool)” may correspond to the action specification “Verify validation Tool”, the method signature “String generateCode(String ruleId, String ruleDescription)” may correspond to the action specification “Generate Compliance Code”, the method signature “void postPR(String code, String platform, String reviewer) may correspond to the action specification “Post Code to Version Control”, the method signature “boolean checkPRApproval(String PR_ID)” may corresponds to the action specification “Enforce SME Approval Before Execution”, the method signature “void executeCode(String code)” may correspond to the action specification “Execute Code Post-Approval”.

The system 202 further is configured to retrieve the set of method descriptions associated with the set of method signatures based on the conversion of the set of action specifications into the set of method signatures. Each method description of the set of method descriptions provides details of the corresponding method signature of the set of method signatures.

By way of an example, and not by limitation, the system 202 retrieves the set of method descriptions based on the conversion. With respect to the example of the first prompt 212A, the method description “Confirm that the provided validation tool is Ansible®; otherwise, it reports an error” may corresponds to the method signature “void verifyValidationTool(String tool)”, the method description “Use defined functions and similar examples to generate an Ansible® playbook based on the rule description.” may corresponds to the method signature “String generateCode(String ruleId, String ruleDescription)”, the method description “Post the generated set of executable instructions as a Pull Request on the version control platform, ensuring it is assigned to an SME for review” may corresponds to the method signature “void postPR(String code, String platform, String reviewer)”, the method description “Validates whether the PR has been approved by an SME before allowing execution” may corresponds to the method signature “boolean checkPRApproval(String PR_ID)”, the method description “Execute the Ansible® playbook only if SME approval has been obtained” may corresponds to the method signature “void executeCode(String Code)”.

Further, the system 202 is configured to generate the second prompt 206, which includes the first prompt 212A, the set of method signatures, and the set of method descriptions. The accuracy score of the second prompt 206 is greater than the accuracy score of the first prompt 212A. In an example, the system 202 is configured to transform the first prompt 212A to generate the second prompt 206. In an example, the second prompt 206 corresponds to the pseudo-structured set of executable instructions, which means the second prompt 206 retains the essence of the user's original request while organizing the second prompt 206 in a way that aligns with the ability of the system 202. For instance, the user 216 inputs the first prompt 212A provided below:
“As an Agent, please write an ansible® playbook to do the following, given new rule with rule_id “ruleA” and description “A is enabled”
   collects OSCAL Assessment Results on SCC eventually
   for that, runs a code on an appropriate verify tool (currently, only Ansible® is supported validation tool, report error if it not Ansible®.)
   the code is generated using some functions with the rule description, similar example can be used to improve the code.
   the code should be posted to Version Control Platform as PR, the PR must be approved by SME. The code should not be run before SME's approval.

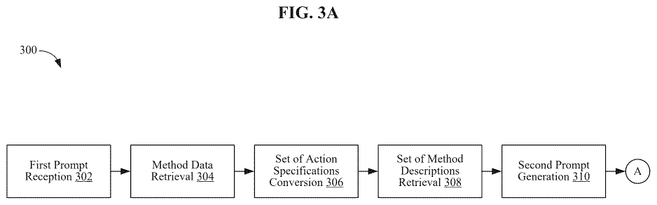

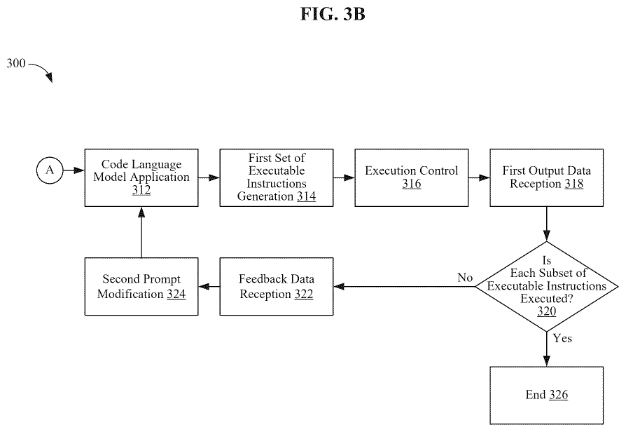

Further, the system 202 analyzes the first prompt 212A and retrieves the method data 210A from the knowledge base 210 to generate the second prompt 206 that describes the parameters of the query. This could include details such as rule_id (ruleA), the type of verify tool (Ansible®), and any additional filters or conditions that may apply, such as SME's approval. Details about the generation of the second prompt 206 are provided in FIG. 3A.

Further, the system 202 is configured to apply the code language model 214 to the second prompt 206. For example, the system 202 utilizes the code language model 214 to enhance understanding of the intent of the user 216. The system 202 is further configured to generate coherent, and contextually appropriate responses based on the utilization of the code language model 214. By leveraging the code language model 214, the system 202 analyzes the structure and semantics of the first prompt 212A.

The utilization of the code language model 214 provides a more sophisticated interpretation of the first prompt 212A, enabling the system 202 to generate responses that are accurate and relevant to the user's specific context. This ability of the system 202 significantly enhances the overall user experience, as the ability allows for more natural and intuitive interactions, ultimately leading to more effective communication between the user 216 and the system 202.

Further, the system 202 is configured to generate the set of executable instructions 204 based on the application of the code language model 214 to the second prompt 206. In an example, the generated set of executable instructions 204 is stored in the database 208 for future reference and processing. Storing the generated set of executable instructions 204 allows the system 202 to maintain a record of user interactions, which may be utilized for analyzing trends, improving response accuracy, and enhancing the overall user experience.

Further, the system 202 is configured to control the execution of at least a subset of executable instructions of the first set of executable instructions 204A. The execution control is promoted by the utilization of the code language model 214, which plays a pivotal role in interpreting the first prompt 212A provided by the user 216. By applying the code language model 214 to the second prompt 206, the system 202 gains a sophisticated understanding of the user's intent and context. The understanding of the user's intent enables the generation of the set of executable instructions 204.

In an example, the system 202 may selectively execute a subset of the first set of executable instructions 204A to address the first prompt 212A. By controlling the execution of instructions, the system 202 ensures that its processes are efficient, targeted, and aligned with the user's intent. The selective execution also minimizes unnecessary processing, further enhancing the system's overall performance and responsiveness. The integration of the code language model 214 with the system 202 thus provides a robust framework for generating, storing, and controlling executable instructions, ultimately leading to a seamless and efficient user interaction experience.

FIG. 3A and FIG. 3B collectively is a block diagram 300 that illustrates one or more operations for the generation of the set of executable instructions 204 based on the code language model 214, in accordance with various embodiments of the disclosure. FIG. 3A and FIG. 3B collectively is explained in conjunction with elements from FIG. 1 and FIG. 2. With reference to FIG. 3A and FIG. 3B, the operations may start at 302.

At 302, a first prompt reception operation is executed. In the first prompt reception operation, the system 202 is configured to receive the first prompt 212A associated with the operational issue. The first prompt 212A is received from the user device 212. For example, the user 216 associated with the user device 212 wants to generate the set of executable instructions 204 from the database 208.

In an example, the first prompt 212A is “As an Agent, please write an ansible® playbook to do the following, given new rule with rule_id “ruleA” and description “A is enabled”
collects Open Security Control Assessment Language (OSCAL) Assessment Results on Supply Chain Cybersecurity (SCC) eventually
for that, runs a code on an appropriate verify tool (currently, only Ansible® is supported validation tool, report error if it not Ansible®.)
the code is generated using some functions with the rule description, similar example can be used to improve the code.
the code should be posted to Version Control Platform as PR, the PR must be approved by SME. The code should not be run before Subject Matter Expert (SME's) approval.”

The first prompt 212A reflects the intent of the user 216 to extract relevant data from the database 208. The relevant data may correspond to a generate the set of executable instructions 204 by using the new rule_id and the description provided. The system 202 provides an interface that allows the user 216 to provide the first prompt 212A in the natural language. In an embodiment, the system 202 can also receive first prompt 212A from a plurality of sources, such as voice-activated assistants, chatbots, or external applications that interface with the database 208. This flexibility in prompt reception enables a broader range of user interaction.

At 304, a method data retrieval operation is executed. In the method data retrieval operation, the system 202 is configured to retrieve the method data from the knowledge base 210 based on the first prompt 212A. The method data 210A includes the set of method signatures associated with the first prompt 212A. The method data 210A corresponds to a detailed description of the set of method signatures.

By way of example, and not by limitation, the system 202 receives the first prompt 212A from the user device 212. The code language model 214 retrieves data from the knowledge base 210 by interpreting the first prompt 212A and generating a query that can extract information relevant to the first prompt 212A. The process of retrieving data often involves processes like Retrieval-Augmented Generation (RAG) and the like, where the code language model 214 combines the understanding of language with external data sources to provide accurate responses. For example, when the user 216 enters the first prompt 212A, the code language model 214 may first analyze the first prompt 212A to identify key terms and concepts related to the first prompt 212A, then the code language model 214 formulates a database query to fetch the vital data from the knowledge base 210. Upon retrieving the relevant information, the code language model 214 synthesizes the retrieved data into a coherent answer, ensuring that the response is both informative and contextually appropriate. The retrieval process typically involves several processes to ensure that the code language model 214 can effectively access and utilize the data stored in the knowledge base 210.

At 306, a set of action specifications conversion operation is executed. In the conversion operation, the system 202 is configured to convert the set of action specifications into the set of method signatures.

By way of example, and not by limitation, the system 202 may use various data processing processes to convert the set of action specifications into the set of method signatures. The various data processing processes may include, but not limited to, the natural language processing (NLP), tokenization refers to breaking down the first prompt 212A into individual words or phrases (tokens), named entity recognition (NER) refers to detecting named entities like dates, monetary amount, locations, regulations, and domains within the first prompt 212A, dependency parsing refers to analyzing the grammatical structure of the prompt and identifies relationships between words within the first prompt 212A and helps in mapping the action specification to the target of resolution of the operational issue, keyword matching refers to the use of defined dictionaries or patterns to match specific keywords, such as regulatory terms (e.g., “GDPR”), or an action verbs (e.g., “validate”, “generate”).

By way of example, and not by limitation, the example of the first prompt is “As an Agent, please write an ansible® playbook to do the following, given new rule with rule_id “ruleA” and description “A is enabled”
collects Open Security Control Assessment Language (OSCAL) Assessment Results on Supply Chain Cybersecurity (SCC) eventually
for that, runs a code on an appropriate verify tool (currently, only Ansible® is supported validation tool, report error if it not Ansible®.)
the code is generated using some functions with the rule description, similar example can be used to improve the code.
the code should be posted to Version Control Platform as PR, the PR must be approved by SME. The code should not be run before Subject Matter Expert (SME's) approval.”

The example of the first prompt 212A may include, but not limited to the action specification of the set of action specifications as “verify validation tool”, “generate compliance code”, post code to version control”, “enforce SME approval before execution”, and “execute code post-approval” as entities of the set of action specifications.

Further, the system 202 may utilize NLP-based parsing to extract compliance rules from the action specification. An NLP module analyzes the input text to identify key actions objects, constraints, and dependencies (e.g., “verify”). It uses dependency parsing, semantic analysis (e.g., “approved by SME”), and named entity recognition (NER) (e.g., “Ansible®”) to break down the natural language instruction into structured components. For example, in the given prompt, “collect Open Security Control Assessment Language (OSCAL) Assessment Results on Supply Chain Cybersecurity (SCC)”, the system identifies “collect” as the action, “OSCAL Assessment Results” as the object, and “Supply Chain Cybersecurity (SCC)” as the contextual domain. Once extracted, this structured data is mapped to known compliance tasks using ontology matching, where the system 202 aligns identified compliance tasks with defined frameworks or benchmarks provided by organizations such as NIST (National Institute of Standards and Technology), ISO (International Organization for Standardization), or CIS (Center for Internet Security) for compliance and best practices security.

Further, after processing the set of action specifications and by applying the various data processing processes on the set of action specifications, the system 202 converts the set of action specifications into the set of method signatures. By way of example, and not by limitation, the method signature “void verifyValidationTool(String tool)” may correspond to the action specification “Verify validation Tool”, the method signature “String generateCode(String ruleId, String ruleDescription)” may correspond to the action specification “Generate Compliance Code”, the method signature “void postPR(String code, String platform, String reviewer) may correspond to the action specification “Post Code to Version Control”, the method signature “boolean checkPRApproval(String PR_ID)” may correspond to the action specification “Enforce SME Approval Before Execution”, the method signature “void executeCode(String code)” may correspond to the action specification “Execute Code Post-Approval”.

At 308, a set of method descriptions retrieval operation is executed. In the set of method descriptions retrieval operation, the system 202 is configured to retrieve the set of method descriptions associated with the set of method signatures based on the conversion of the set of action specifications into the set of method signatures. The method data includes the set of method descriptions. Each method description of the set of method descriptions is associated with the corresponding method signature of the set of method signatures.

By way of example, and not by limitation, with respect to the conversion of the set of action specifications into the set of method signatures, the method description “Confirm that the provided validation tool is Ansible®; otherwise, it reports an error” may corresponds to the method signature “void verifyValidationTool(String tool)”, the method description “Use defined functions and similar examples to generate an Ansible® playbook based on the rule description.” may corresponds to the method signature “String generateCode(String ruleId, String ruleDescription)”, the method description “Post the generated set of executable instructions as a Pull Request on the version control platform, ensuring it is assigned to an SME for review” may corresponds to the method signature “void postPR(String code, String platform, String reviewer)”, the method description “Validates whether the PR has been approved by an SME before allowing execution” may corresponds to the method signature “boolean checkPRApproval(String PR_ID)”, the method description “Execute the Ansible® playbook only if SME approval has been obtained” may corresponds to the method signature “void executeCode(String Code)”.

At 310, a second prompt generation operation is executed. In the second prompt generation operation, the system 202 is configured to generate the second prompt 206. The second prompt 206, which includes the first prompt 212A, the set of method signatures, and the set of method descriptions is generated based on the reception of the first prompt 212A and the retrieval of the method data 210A from the knowledge base 210. In an example, the second prompt 206 may correspond to the pseudo-code associated with the first prompt 212A. By way of example, and not by limitation, the system 202 is configured to generate the second prompt 206 that reflects a more detailed and structured interpretation of the first prompt 212A.

By way of example, and not by limitation, the example of the first prompt 212A is provided below:
“As an Agent, please write an ansible® playbook to do the following, given new rule with rule_id “ruleA” and description “A is enabled”
   collects OSCAL Assessment Results on SCC eventually
   for that, runs a code on an appropriate verify tool (currently, only Ansible® is supported validation tool, report error if it not Ansible®.)
   the code is generated using some functions with the rule description, similar example can be used to improve the code.
   the code should be posted to Version Control Platform as PR, the PR must be approved by SME. The code should not be run before SME's approval.”

Further, the system 202 generates the second prompt 206 based on the example of the first prompt 212A provided above and the method data 210A. Further, the method data 210A associated with the first prompt 212A is received from the knowledge base 210. Further, the system 202 computes the accuracy score of the first prompt 212A. The accuracy score of the first prompt 212A indicates the degree of accuracy of the first prompt 212A.

By way of example, and not by limitation, the system 202 computes the accuracy score of the first prompt 212A for generating the ansible® playbook. The system 202 defines evaluation metrics by utilizing ground truth data and implementing a robust evaluation process. In an embodiment, the evaluation metrics correspond to quantitative measures used to evaluate the performance of a model against defined criteria. Further, the ground truth data refers to data used for comparison to evaluate the correctness of the output generated by the code language model 214 by evaluating predictions against actual values in tasks such as classification, regression, object detection, segmentation, and natural language processing.

The first prompt 212A specifies several key requirements such as the ansible®-playbook must implement a new rule with a specific rule_id and description, validate the code using the ansible®, and ensure that the code is posted to a version control platform as a pull request that requires approval from a Subject Matter Expert (SME) before execution. To evaluate the accuracy of the generated ansible® playbook, the evaluation metrics such as precision, recall, and F1 score can be employed. The precision measures the proportion of correctly generated elements within the ansible® playbook compared to total number of elements generated. Further, the recall considers the proportion of correctly generated elements against each vital element. The vital elements are the tasks or configurations within a process that are vital for achieving its intended functionality or objectives. The F1 score provides a balanced measure of both the precision and the recall, making the F1 score a valuable metric for evaluating the overall performance of the code language model 214.

For example, consider a scenario where the code language model 214 generates multiple ansible® playbooks in response to the first prompt 212A. Each generated ansible® playbook can be compared against a set of ideal outputs that meet specified criteria. If the ideal ansible® playbook includes processes for collecting OSCAL Assessment Results, validating the code with the ansible®, and posting the code to the version control platform with a requirement for the SME approval, these elements serve as the ground truth. If the code language model 214 produces the ansible® playbook that successfully implements every process, the generated ansible® playbook would be classified as a true positive. Conversely, if the generated ansible® playbook uses a different validation tool, such as a shell script, or omits the SME approval process, these would be classified as false negatives.

For example, consider a scenario, where the evaluation involves 100 generated ansible® playbooks. If 85 of these ansible® playbooks correctly implement the vital processes, the accuracy score of the first prompt 212A would be calculated as follows:
True Positives (TP): 85 (correctly generated ansible® playbooks)
False Positives (FP): 5 (incorrectly generated ansible® playbooks that still met some criteria)
False Negatives (FN): 10 (playbooks that failed to meet the requirements)
Using these values, precision would be calculated as TP/(TP+FP)=85/(85+5)=0.94, or 94%. Recall would be calculated as TP/(TP+FN)=85/(85+10)=0.89, or 89%. The F1 score, which balances precision and recall, would be calculated as 2*(Precision*Recall)/(Precision+Recall)=2*(0.94*0.89)/(0.94+0.89)≈0.91, or 91%.

Further, the system 202 generates the second prompt 206 as “You are a compliance assessment agent for performing compliance assessment, who is an expert on regulatory controls, security verification programs by Ansible® Playbook, and GRC (Governance, Risk, Compliance) tools. The compliance assessor routinely understands compliance requirements, writes the ansible® playbook to fetch and verify the status from target systems, deploys the playbook to an ansible® automation platform, and gathers playbook job results via Compliance-to-Policy (C2P). You do the same as what the compliance assessor does routinely. For taking an action, you can use the ansible® playbook. In the ansible® playbook, you can leverage the following modules.
1. You can use a module polaris.apg.get_validation_tools_for_rule defined below for getting the validation tool used for a rule_id.
   name: Getting the validation tool
   polaris.apg.get_validation_tools_for_rule:
      rule_id: rule_id
   register: name_of_validation_tool where:
   the registered value “name_of_validation_tool” is the name of validation tool, which should be “Ansible®” or “Auditree”.
2. You can use a module polaris.apg.get_similar_ansible®_playbooks defined below for getting Ansible® Playbooks semantically similar to the provided description desc.
   name: Getting Similar Playbook
   polaris.apg.get_similar_ansible®_playbooks:
      text: desc
   register: similar_playbook where:
   “text” parameter of this module specifies description which is used to identify a similar playbook.

The registered value “similar_playbook” is a playbook semantically similar to the provided description “desc”.
3. You can use a module polaris.apg.generate_similar_ansible®_playbooks defined below for Ansible® Playbook from the provided prompt “text”.
   def generate_ansible®_playbook (text: str, example: str)->str:
   name: Generate Ansible® Playbook
   polaris.apg.generate_similar_ansible®_playbooks:
      text: mytext
   example: myexample
   register: generated_playbook where:
   “text” parameter of this module specifies text which explains playbook to be generated.
   “example” parameter of this module specifies an example playbook semantically similar to the “mytext”.
   the registered value “generated_playbook” is a playbook generated.
4. You can use a module polaris.apg.c2p_p2c defined below for generating OSCAL Assessment Results from job results and a component-definition file.
   name: Generate OSCAL Assessment Results
   polaris.apg.c2p_p2c:
   cdef: component_definition_path
   input: job_results_directory
   output: output_directory where:
   “cdef” is the path to the component-definition.json file.
   “input” is the path to the job results directory.
   “output” is the path to the directory where the generated OSCAL Assessment Results will be stored.
5. You can use a module polaris.apg.c2p_push_to_ssc defined below for pushing OSCAL Assessment Results to SCC.
   name: Pushing OSCAL Assessment Results to SCC
   polaris.apg.c2p_push_to_p2c:
      input: oscal_results_path
   register: push_result where:
   “input” is the path to the OSCAL Assessment Results.
   the registered value “push_result” contains the profile name and attachment name.
      As an Agent, please write an ansible® playbook to do the following, given new rule with rule_id “ruleA” and description “A is enabled”
   collects OSCAL Assessment Results on SCC eventually
   for that, runs a code on an appropriate verify tool (currently, only Ansible® is supported validation tool, report error if it not Ansible®.)
   the code is generated using some functions with the rule description, similar example can be used to improve the code.
   the code should be posted to Version Control Platform as PR, the PR must be approved by SME. The code should not be run before SME's approval.”

The structured approach ensures that the system 202 retrieves accurate data (such as proper modules and libraries related to the first prompt 212A provided by the user 216), providing the user 216 with a desired outcome in the ansible® playbook. Further, the system 202 computes the accuracy score of the second prompt 206. The accuracy score of the second prompt 206 indicates the degree of accuracy of the second prompt 206.

By way of example, and not by limitation, the system 202 computes the accuracy score of the second prompt 206 for generating the ansible® playbook, a structured evaluation process is used similar to that used for the first prompt 212A. The second prompt 206 is more detailed and provides specific modules and functions that the code language model 214 can leverage to generate the vital ansible® playbook. The specific modules and the functions enhance the clarity of the task and set clear expectations for the output. The system 202 determines evaluation metrics such as the precision, the recall, and the F1 score to evaluate the quality of the generated ansible® playbook against the ground truth data. The ground truth data, in this case, would consist of ideal ansible® playbooks that fulfill every specified requirement, including the use of the provided modules and the correct handling of the rule with rule_id and description.

For example, if the code language model 214 generates the ansible® playbook that successfully implements the vital processes such as using the “polaris.apg.get_validation_tools_for_rule” module to verify for the validation tool, generating a similar ansible® playbook using “polaris.apg.generate_similar_ansible®_playbooks”, and pushing OSCAL Assessment Results to SCC using “polaris.apg.c2p_push_to_ssc” the generated ansible® playbook would be classified as a true positive. Conversely, if the generated ansible® playbook fails to include the vital processes or incorrectly uses a different validation tool, these would be classified as false negatives.

For example, consider a scenario, the system 202 evaluates 100 generated ansible® playbooks based on the second prompt 206. If 90 of these playbooks correctly implement every vital module and process, the accuracy score of the second prompt 206 can be calculated as follows:
True Positives (TP): 90 (correctly generated ansible® playbooks)
False Positives (FP): 5 (ansible® playbooks that met some criteria but were not fully correct)
False Negatives (FN): 5 (ansible® playbooks that failed to meet the requirements)
Using these values, precision would be calculated as TP/(TP+FP)=90/(90+5)=0.95, or 95%. Recall would be calculated as TP/(TP+FN)=90/(90+5)=0.95, or 95%. The F1 score, which balances precision and recall, would be calculated as 2*(Precision*Recall)/(Precision+Recall)=2*(0.95*0.95)/(0.95+0.95)≈0.95, or 95%.

The evaluation quantifies the performance of the code language model 214 and highlights the improvements made in the output generated using the second prompt 206. By continuously refining the prompts and evaluating the results, the system 202 enhances the effectiveness of the code language model 214 in generating accurate ansible® playbooks personalized to compliance problems. The accuracy score of the second prompt 206 is greater than the accuracy score of the first prompt 212A as the first prompt 212A is poorly defined data as compared to the second prompt 206 for input to the system 202. The high accuracy score of the second prompt 206 significantly enhances the performance of the system 202 by enabling low processing times, as fewer errors reduce the need for manual review and allow for quicker deployment of the ansible® playbooks. The high accuracy score of the second prompt 206 also decreases the computational load, enabling the system 202 to handle more requests efficiently without compromising performance. Furthermore, the continuous refinement of prompts based on performance evaluations allows the system 202 to scale effectively, adapting to larger datasets and more complex scenarios without a proportional increase in error rates.

By way of example, and not by limitation, the system 202 computes the accuracy score of the first prompt as 0.91 and the accuracy score of the second prompt 206 as 0.95. The accuracy score of the second prompt 206 is greater than the accuracy score of the first prompt 212A.

At 312, a code language model application operation is executed. In the code language model application operation, the system 202 is configured to apply the code language model 214 to the second prompt 206. For example, the code language model 214 may allow the system 202 to interpret the second prompt 206 and promote accurate data retrieval from the database 208. The code language model 214 is configured to comprehend and generate the set of executable instructions 204. By applying the code language model 214 to the second prompt 206, the system 202 interprets the relationship between the first prompt 212A and the set of method signatures more effectively.

Furthermore, the application of the code language model 214 allows the system 202 to generate more nuanced and contextually appropriate responses. The code language model 214 may consider various factors, such as the user's previous interactions (which inform the code language model 214 about the preferred programming language for the generation of the set of executable instructions 204). If the user 216 has previously specified a programming language, then the code language model 214 will generate code in that programming language. However, if the programming language is not explicitly mentioned, the code language model 214 will infer the appropriate language based on the context of prior interactions, preferences, and the specific regulatory guidelines (particularly in sensitive domains, as the code language model 214 must comply with relevant standards such as General Data Protection Regulation (GDPR) or Health Insurance Portability and Accountability Act (HIPAA), thereby mitigating risks associated with the dissemination of sensitive information) that apply to the first prompt 212A. This results in a more personalized and relevant output, enhancing the overall user experience.

At 314, a first set of instructions generation operation is executed. In the first set of executable instructions generation operation, the system 202 is configured to generate the first set of executable instructions 204A based on the application of the code language model 214 to the second prompt 206. By way of example, and not by limitation, the system 202 is configured to process the second prompt 206 and apply the code language model 214 to generate the first set of executable instructions 204A relevant to the task specified in the first prompt 212A.

By way of example, and not by limitation, the system 202 generates the set of executable instructions 204 based on the second prompt 206. For instance, the set of executable instructions 204 may be:
Below is the Ansible® Playbook that fulfills the given requirements. It retrieves the validation tool, generates the vital ansible® playbook based on the rule description, creates a pull request for SME approval, and runs the playbook once the pull request is approved. Finally, it collects and pushes the OSCAL Assessment Results to SCC.
name: Compliance Assessment for ruleA
hosts: localhost
tasks:
   1.—name: Getting the validation tool for ruleA
      polaris.apg.get_validation_tools_for_rule:
         rule_id: “ruleA”
      register: validation_tool
   2.—name: Verifying if validation is Ansible®
      fail:
         msg: “Validation tool for ruleA is not Ansible®, aborting.”
      when: validation_tool.name_of_validation_tool!=“Ansible®”
   3.—name: Getting similar playbooks for rule description “A is enabled”
      polaris.apg.get_similar_ansible®_playbooks:
         text: “A is enabled”
      register: similar_playbook
   4.—name: Generate playbook for ruleA based on description and similar playbook
      polaris.apg.generate_ansible®_playbooks:
         text: “Ensure that A is enabled”
         example: “{{generated_playbook.generated_playbook}}”
      register: generated_playbook
   5.—name: Generate OSCAL Assessment Results
      polaris.apg.c2p_p2c:
         cdef: “/path/to/component-definition.json”
         input: “/path/to/job/results”
         output: “/path/to/oscal/results”
   6.—name: Pushing OSCAL Assessment Results to SCC
      polaris.apg.c2p_push_to_scc:
         input: “/path/to/oscal/results”
      register: push_result
   7.—name: Displaying the push result
      debug:
         msg: “Assessment Results pushed to Scc with profile: {{push_result.profile_name}

Note that only an example of generating the set of executable instructions 204 in the ansible® playbook has been provided, however, the set of executable instructions 204 may be generated in any programming language from the set of programming languages linked with the knowledge base 210, such as Python® and the like.

The first set of executable instructions 204A may include code snippets, function calls, or workflow definitions tailored to address the operational issue identified in the first prompt 212A. The first set of executable instructions 204A represents the initial output generated by the system 202 based on the second prompt 206. Once the set of executable instructions 204 is generated, the system 202 enters a refinement loop to ensure that the set of executable instructions 204 comprehensively addresses the operational issue and meets the desired level of precision and accuracy. The iterative process (from the second prompt modification operation 324 to the code language model application operation 312) involves modifying the second prompt 206. The iterative process considers feedback, additional context, or any gaps identified during the generation of the first set of executable instructions 204A.

After modifying the second prompt 206, the system 202 applies the code language model 214 to the modified second prompt 206. Further, the system 202 generates a second set of executable instructions 204B. The second set of executable instructions 204B may incorporate any adjustments or enhancements made during the iterative process. The iterative process from modifying the second prompt 206 and generating an updated set of executable instructions continues until each subset of executable instructions of the set of executable instructions 204 is completed and fully aligned with the requirements of the operational issue The iterative process ensures that any ambiguities or incomplete aspects of the initial instructions are resolved before proceeding to the next process.

At 316, an execution control operation is performed. In the execution control operation, the system 202 is configured to control the execution of at least a subset of executable instructions of the set of executable instructions 204. The execution control operation involves the system 202 coordinating the execution of the subset of instructions to achieve the desired outcome while ensuring compliance with the specific regulatory guidelines. This desired outcome encompasses not only the successful completion of tasks, such as data analysis, report generation, or transaction processing, but also the adherence to the specific regulatory guidelines governing data integrity and security. The execution control may include scheduling the set of executable instructions 204, managing dependencies between tasks, and monitoring the execution process for errors or interruptions. By dynamically managing the execution of the subset of executable instructions, the system 202 ensures that the set of executable instructions 204 is executed efficiently and produces the desired outcome.

By way of example, and not by limitation, the system 202 may execute the generated set of executable instructions 204 sequentially or in parallel, depending on the dependencies between the set of executable instructions 204. For example, the subset of executable instructions may pertain to automating a business workflow, such as generating a financial report. By leveraging the structured nature of the executable instructions and contextual inputs, the system 202 guarantees accurate and timely execution of the subset of instructions.

By way of example, and not by limitation, the set of executable instructions 204 generated by the system 202 based on the second prompt 206 is provided below:
name: Compliance Assessment for ruleA
hosts: localhost
tasks:
   1.—name: Getting the validation tool for ruleA
      polaris.apg.get_validation_tools_for_rule:
         rule_id: “ruleA”
      register: validation_tool
   2.—name: Verifying if validation is Ansible®
      fail:
         msg: “Validation tool for ruleA is not Ansible®, aborting.”
      when: validation_tool.name_of_validation_tool!=“Ansible®”
   3.—name: Getting similar playbooks for rule description “A is enabled”
      polaris.apg.get_similar_ansible®_playbooks:
         text: “A is enabled”
      register: similar_playbook
   4.—name: Generate playbook for ruleA based on description and similar playbook
      polaris.apg.generate_ansible®_playbooks:
         text: “Ensure that A is enabled”
         example: “{{generated_playbook.generated_playbook}}”
      register: generated_playbook
   5.—name: Generate OSCAL Assessment Results
      polaris.apg.c2p_p2c:
         cdef: “/path/to/component-definition.json”
         input: “/path/to/job/results”
         output: “/path/to/oscal/results”
   6.—name: Pushing OSCAL Assessment Results to SCC
      polaris.apg.c2p_push_to_scc:
         input: “/path/to/oscal/results”
      register: push_result
   7.—name: Displaying the push result
      debug:
         msg: “Assessment Results pushed to Scc with profile: {{push_result.profile_name}

By way of example, and not by limitation, the system 202 controls the execution by executing the first subset of executable instructions of the set of executable instructions 204 as
name: Getting the validation tool for ruleA
polaris.apg.get_validation_tools_for_rule:
   rule_id: “ruleA”
register: validation_tool

Further, the system 202 executes the second subset of executable instructions 204B of the set of executable instructions 204 as
name: Verifying if validation is Ansible®
fail:
   msg: “Validation tool for ruleA is not Ansible®, aborting.”
when: validation_tool.name_of_validation_tool!=“Ansible®”

Similarly, the system 202 controls the execution of each of the subset of executable instructions of the set of executable instructions 204 until each of the subset of executable instructions of the set of executable instructions 204 is executed.

At 318, a first output data reception operation is performed. In the first output data reception operation, the system 202 is configured to receive the first output data based on the execution of the first set of executable instructions 204A. Further, the system 202 receives the first output data generated as a result of executing the subset of executable instructions of the first set of executable instructions 204A. The first output data may include, but not limited to, results, and logs, generated upon the execution of the subset of instructions. The first output data serves as feedback to validate whether the subset of executable instructions achieved the desired objectives or if further iterations are vital. Additionally, the received first output data may include performance metrics or error logs that aid in refining the subsequent second prompt 206 or identifying potential issues.

In an example, if the subset of executable instructions pertains to a data analysis workflow, the first output data may include the processed dataset or visualization generated by the first set of executable instructions 204A. The received first output data may then be utilized to modify further prompts or to create actionable insights based on the analysis results.

Further, after modifying the second prompt 206, the iterative loop continues as the system 202 applies the code language model 214 (such as the LLM) to the modified second prompt. The process generates a new set of executable instructions based on the modified second prompt, addressing the gaps or errors identified in the previous iteration. The new set of instructions is then executed, and subsequent feedback is collected to further modify the second prompt 206 if needed. The iterative loop ensures continuous improvement and precision in resolving the operational issue, allowing the system 202 to adapt dynamically to user requirements and execution feedback.

At 320, the system 202 determines whether each subset of executable instructions of the set of executable instructions 204 has been executed. In a scenario, if the system 202 determines that the each subset of the set of executable instructions 204 has been executed, then the control may pass to 326 and the iterative loop is considered finalized. In an alternate embodiment, if the system 202 determines that each subset of executable instructions of the set of executable instructions 204 has not been executed, then the control may pass to 322.

By way of example, and not by limitation, in a business workflow for processing customer orders, once each task such as order validation, inventory verification, payment processing, and shipping updates are executed, the process is marked complete. However, if certain subsets remain unexecuted or encounter errors (e.g., an order update fails to reflect in the customer database), feedback data is collected for those specific tasks. The feedback data is used to modify the second prompt 206, which is reprocessed through the code language model application operation 312 to generate a new or modified set of executable instructions for execution. The iterative loop ensures that the system 202 adapts and resolves any pending tasks, enabling robust and accurate execution of business workflows.

At 322, a feedback data reception operation is executed. The system 202 receives feedback data related to the execution of the subset of executable instructions. The feedback data serves as a vital input to evaluate the effectiveness and correctness of the executed instructions and to identify areas requiring refinement. The feedback data may include error reports, execution logs, performance metrics, or contextual information highlighting discrepancies between the expected and actual outcomes. The feedback data enables the system 202 to gather insights vital for iterative improvement and ensures alignment with the problem requirements.

By way of example, and not by limitation, in a business workflow for processing customer orders, if the generated subset of executable instructions is intended to validate orders, verify inventory, process payments, and update shipping information, the feedback data may indicate that certain tasks failed to execute correctly, such as an order validation error or an inventory verify that did not reflect the current stock levels. The feedback data may be received from the user device 212 associated with the user 216. Additionally, the feedback data may include metrics such as order processing times, error rates in payment transactions, or discrepancies in shipping updates. This feedback provides vital insights to refine the second prompt 206 iterations of the workflow, ensuring robust and accurate execution of business processes.

At 324, a second prompt modification operation is performed. In the second prompt modification operation, the system 202 is configured to modify the second prompt 206 based on the received feedback data. The system 202 modifies the second prompt 206 to address any gaps, errors, or inefficiencies observed in the execution of the subset of executable instructions of the set of executable instructions 204. The modification of the second prompt 206 involves adjusting the second prompt 206 to incorporate new or revised contextual elements, constraints, or task requirements. By leveraging the feedback data, the system 202 ensures that the modified second prompt captures a more comprehensive and precise representation of the operational issue.

By way of example, and not by limitation, if the feedback data from a customer order processing workflow indicates that order validation failed due to incorrect customer information, the second prompt 206 is modified to include additional processes for validating customer data before execution. The modification of the second prompt 206 ensures accurate processing of customer orders and prevents future validation errors. Similarly, if the feedback data reveals inventory issues due to outdated stock information, the second prompt 206 is modified to include a process for real-time synchronization with the database 208. The modifications to the second prompt 206 help align the system 202 with the dynamic requirements of business workflows, ensuring accurate and efficient execution.

At 326, when each subset of executable instructions of the set of executable instructions 204 is executed the system 202 ends the iterative loop of modifying the second prompt 206 based on the received feedback data.

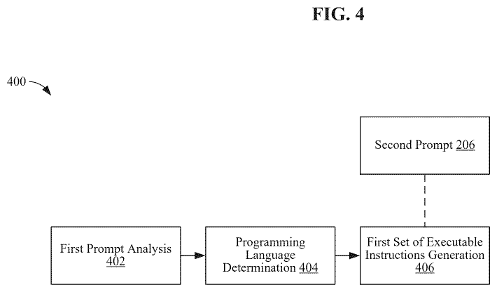

FIG. 4 is a diagram that illustrates a block diagram 400 of exemplary operations performed by the system 202 for the generation of the set of executable instructions 204 based on the code language model 214, in accordance with various embodiments of the disclosure. FIG. 4 is explained in conjunction with the elements from FIG. 1, FIG. 2, FIG. 3A, and FIG. 3B. With reference to FIG. 4, the operations may start at 402.

At 402, a first prompt analysis operation is executed. In the first prompt analysis operation, the system 202 is configured to analyze the first prompt 212A received from the user device 212 to extract vital business-related data, like workflow limitations (refer to constraints or bottlenecks within a business process that may hinder efficiency or effectiveness), industry-specific standards (which are established guidelines and best practices that govern processes within a particular sector to ensure quality and safety), regulatory rules (legal requirements imposed by governmental or regulatory bodies), and compliance requirements (which are the specific obligations that organizations must fulfill to meet legal, ethical, and operational standards relevant to the industry) from the knowledge base 210. The system 202 examines the first prompt 212A and may utilize natural language processing (NLP) processes to interpret the intent behind the user's request and determine whether the first prompt 212A pertains to tasks such as business process automation, financial auditing, regulatory reporting, or data compliance. Additionally, the system 202 analyzes whether the user 216 has specifically specified a programming language in the first prompt 212A or may need to infer the programming language based on the task context. Additionally, the system 202 may leverage historical user interactions and defined compliance templates to enhance its understanding of the request.

By way of example, and not by limitation, if the user provides the first prompt: “Generate a script to validate General Data Protection Regulation (GDPR) compliance for customer data storage,” the system 202 analyzes the first prompt 212A and identifies that the task relates to regulatory compliance for data protection. Further, the system 202 verifies to find out if a particular programming language like the python® or java® has been mentioned in the first prompt 212A by the user 216.

At 404, a programming language determination operation is executed. In the programming language determination operation, the system 202 is configured to determine the most appropriate programming language for generating compliance-related code based on the first prompt 212A analysis. If the user explicitly mentions a programming language (e.g., “Generate a python® script to validate General Data Protection Regulation (GDPR) compliance for customer data storage”, then the system 202 directly selects the specified language and generates the set of executable instructions 204 in that particular programming language specified in the first prompt 212A. However, if the programming language is not explicitly stated, the system 202 generates the set of executable instructions 204 based on the user's previous interactions, preferences, and established patterns observed in prior requests. This approach ensures that the generated set of executable instructions 204 is according to the user's specific needs and aligns with the familiarity and comfort with particular programming languages. Additionally, industry standards may be referenced to determine the most appropriate language for compliance validation. For instance, the python® may be selected due to its robust functions for managing encryption, data verification, and compliance record logging.

At 406, a first set of executable instructions generation operation is executed. The first set of executable instructions generation operation 406 is similar to the first set of executable instructions generation operation 314 described in FIG. 3B. In the first set of executable instructions generation operation, the system 202 is configured to generate the first set of executable instructions 204A based on the determination of the programming language and the second prompt 206. Further, the system 202 applies the code language model 214 to generate the first set of executable instructions 204A. The code language model 214 processes the structured compliance requirements and regulatory guidelines identified in the first prompt 212A to generate a well-formed, secure, and efficient first set of executable instructions 204A. This could include the specific obligations that organizations must fulfill to meet legal, ethical, and operational standards relevant to the industry. Additionally, the system 202 may incorporate compliance rules (specific guidelines and regulations that govern the processes of an organization, ensuring that processes adhere to legal, regulatory, and industry standards), logging mechanisms (processes for recording events, transactions, and changes within a system, providing a detailed audit trail that promotes monitoring, analysis, and accountability), and error-handling features (programmed functionalities designed to detect, manage, and respond to errors or exceptions that occur during the execution of a process) to ensure accuracy and traceability. The compliance rules, the logging mechanisms, and the error-handling features rules may be stored within the knowledge base 210.

By way of example, and not by limitation, if the example of first prompt 212A corresponds to “Develop a python® script to verify financial transactions against Anti-Money Laundering regulations (AML),” the system 202 generates a python® script (indicating the set of executable instructions 204 in the python®) after generating the second prompt 206 that verifies transactions based on defined AML thresholds and flags suspicious activities. The generated first set of executable instructions 204A may use financial compliance libraries and data validation frameworks to ensure regulatory adherence. If the user 216 had specified the ansible®-playbook or any programming language of the set of programming languages instead of the python® script, the system 202 will generate the set of executable instructions 204 in the ansible® playbook or any programming language based on the user's previous interactions and preferences, ensuring that the output is according to the user's established requirements and familiarity.

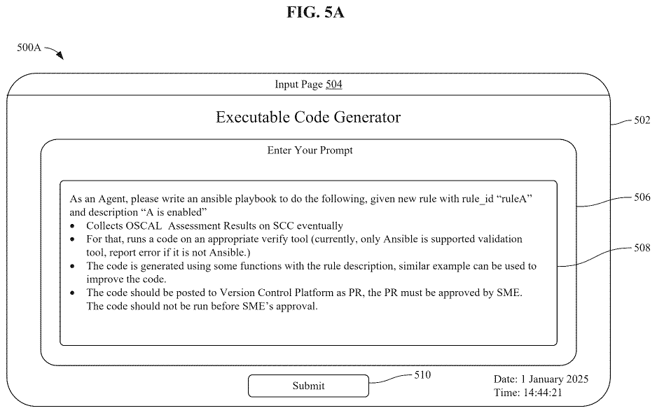

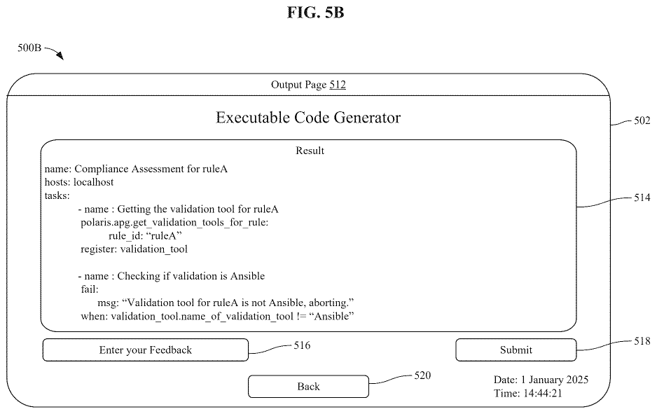

FIG. 5A is a diagram that illustrates an example of first user interface (UI) for performing the set of executable instructions 204 generation based on the code language model 214, in accordance with various embodiments of the disclosure. FIG. 5A is explained in conjunction with elements from FIG. 1, FIG. 2, FIG. 3A, FIG. 3B, and FIG. 4. With reference to FIG. 5A, there is shown an exemplary diagram 500A that includes a user device 502 and an input page 504. The input page 504 includes a first user interface (UI) element 506, a second UI element 508, and a third UI element 510. The user device 502 is an example embodiment of the user device 212 of FIG. 2.

With reference to FIG. 5A, the system 202 receives the first prompt 212A from the user device 502 (e.g., the user device 212). The user device 502 includes a display unit (a user interface) that renders the input page 504 to the user device 502 associated with the user 216. The input page 504 corresponds to a web page or online form that is designed to receive input or commands (e.g., first prompt 212A) from the user 216. In an example, user prompts are commonly used in various applications, including programming environments, database management systems, and software tools, allowing users to execute commands, ask questions, or provide information. In an embodiment of the disclosure, the input page 504 is used to gather relevant details from the knowledge base 210 for the generation of the set of executable instructions 204 associated with the first prompt 212A.

The user device 502 provides seamless interaction between the user 216 and the system 202, ensuring that users easily input the queries and receive relevant information. The first UI element 506 is a display box with a message, such as “Enter Your Prompt.” For example, the first UI element 506 includes the second UI element 508. The second UI element 508 corresponds to a text box, which is designated for capturing the first prompt 212A from the user device 502.

To further enhance the user experience, the input page 504 includes the third UI element 510, which corresponds to a button labeled as “Submit”. The “submit” button plays a vital role in the interaction process. Once the user 216 has entered the first prompt 212A into the second UI element 508, they may click on the third UI element 510 to submit the request. This action signals the system 202 to begin processing the first prompt 212A.

Upon clicking the submit button, the system 202 transitions from the input phase to the processing phase. The system 202 begins to execute the algorithms and queries to retrieve the requested information. For instance, when the user 216 types the query into the second UI element 508, the system 202 is prepared to process the information. For example, if the user 216 inputs the first prompt “As an Agent, please write an ansible® playbook to do the following, given new rule with rule_id “ruleA” and description “A is enabled”
collects Open Security Control Assessment Language (OSCAL) Assessment Results on Supply Chain Cybersecurity (SCC) eventually
for that, runs a code on an appropriate verify tool (currently, only Ansible® is supported validation tool, report error if it is not Ansible®.)
the code is generated using some functions with the rule description, similar example can be used to improve the code.
the code should be posted to Version Control Platform as PR, the PR must be approved by SME. The code should not be run before Subject Matter Expert (SME's) approval.”

Then upon receiving the first prompt 212A, the system 202 initiates a comprehensive analysis of the input. This analysis includes the utilization of the code language model 214 which interprets the user's request (e.g., the first prompt 212A), breaking the first prompt 212A down into understandable components. The code language model 214 is trained to recognize various phrases and terminologies to discern the intent behind the user's query. In conjunction with this, the system 202 also leverages its business knowledge from the knowledge base 210, which provides context and relevance to the data being requested. This dual approach ensures that the system 202 may accurately interpret the user's demands and deliver the desired outcomes.

FIG. 5B is a diagram that illustrates an example of a second User Interface (UI) for performing the set of executable instructions 204 generation based on the code language model 214, in accordance with various embodiments of the disclosure. FIG. 5B is explained in conjunction with elements from FIG. 1, FIG. 2, FIG. 3A, FIG. 3B, FIG. 4, and FIG. 5A. With reference to FIG. 5B, there is shown an exemplary diagram 500B that includes the user device 502 and an output page 512.

In an embodiment, the user device 502 is equipped with a display unit configured to render the output page 512 based on the interaction of the user 216 with a graphical user interface (GUI). Specifically, when the user 216 selects the third UI element 510, the system 202 responds by generating and displaying an output page number that corresponds to the set of executable instructions 204 associated with the first prompt 212A entered in the second UI element 508. This interaction is intended to provide a smooth user experience by allowing users to simply access and comprehend the results of the queries.

The executable instructions output is presented in a fourth UI element 514. For instance, if the user 216 inputs the first prompt 212A “As an Agent, please write an ansible® playbook to do the following, given new rule with rule_id “ruleA” and description “A is enabled”
collects Open Security Control Assessment Language (OSCAL) Assessment Results on Supply Chain Cybersecurity (SCC) eventually
for that, runs a code on an appropriate verify tool (currently, only Ansible® is supported validation tool, report error if it is not Ansible®.)
the code is generated using some functions with the rule description, similar example can be used to improve the code.
the code should be posted to Version Control Platform as PR, the PR must be approved by SME. The code should not be run before Subject Matter Expert (SME's) approval.”

The system 202 leverages the knowledge base 210 to receive the method data 210A and generate the second prompt 206.

Further, the system 202 utilizes the generated second prompt 206 and the code language model 214 to generate the set of executable instructions 204 and render the generated set of executable instructions 204 in the fourth UI element 514. The system 202 may render the generated set of executable instructions 204 as:
name: Compliance Assessment for ruleA
hosts: localhost
tasks:
   name: Getting the validation tool for ruleA
   polaris.apg.get_validation_tools_for_rule:
      rule_id: “ruleA”
   register: validation_tool
   name: Verifying if validation is Ansible®
   fail:
      msg: “Validation tool for ruleA is not Ansible®, aborting.”
   when: validation_tool.name_of_validation_tool!=“Ansible®”
   name: Getting similar playbooks for rule description “A is enabled”
   polaris.apg.get_similar_ansible®_playbooks:
      text: “A is enabled”
   register: similar_playbook
   name: Generate playbook for ruleA based on description and similar playbook
      polaris.apg.generate_ansible®_playbooks:
         text: “Ensure that A is enabled”
         example: “{{generated_playbook.generated_playbook}}”
      register: generated_playbook
   name: Generate OSCAL Assessment Results
      polaris.apg.c2p_p2c:
         cdef: “/path/to/component-definition.json”
         input: “/path/to/job/results”
         output: “/path/to/oscal/results”
   name: Pushing OSCAL Assessment Results to SCC
      polaris.apg.c2p_push_to_scc:
         input: “/path/to/oscal/results”
      register: push_result
   name: Displaying the push result
      debug:
         msg: “Assessment Results pushed to Scc with profile: {{push_result.profile_name}

In addition to the set of executable instructions 204, the output page 512 is designed to enhance user interaction through additional UI elements. The output page 512 may include a fifth UI element 516, a sixth UI element 518, and a seventh UI element 520. The fifth UI element 516 is designed to receive user feedback regarding the set of executable instructions 204. This feedback mechanism is vital for continuous improvement, as the feedback allows users to express satisfaction or concerns about the output received.

Once the user provides the feedback data through the fifth UI element 516, the sixth UI element 518 features a button that, when clicked, transmits the feedback data back to the system 202 and the system 202 modifies the second prompt 206 based on the received feedback data. This feedback loop is vital for modifying the performance of the system 202 and ensuring that the generated set of executable instructions 204 aligns with the expectations of the user 216. The system 202 analyzes the feedback data to make adjustments, improving the accuracy and relevance of future outputs.

Further, if the user 216 is satisfied with the output displayed in the fourth UI element 514, the seventh UI element 520 offers an option to return to the input page 504. This functionality allows the user 216 to easily initiate new prompts without navigating through multiple screens, thereby streamlining the overall user experience.

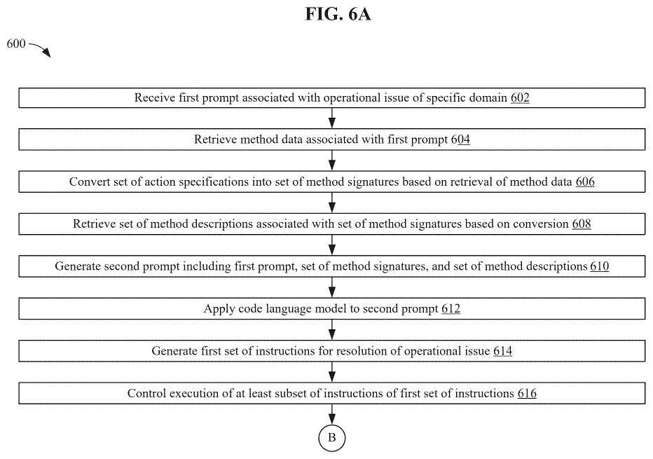

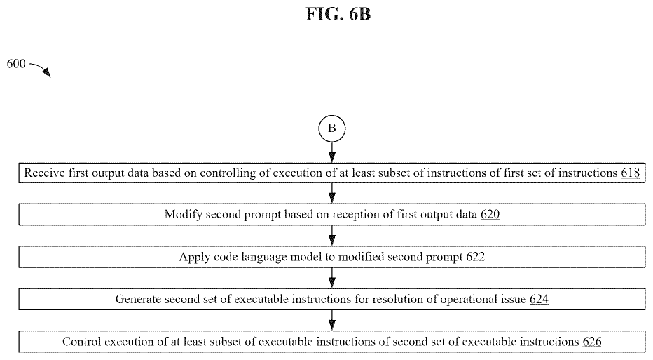

FIG. 6A and FIG. 6B collectively illustrates a flowchart 600 of an exemplary method for the generation of the set of executable instructions 204 based on the code language model 214, in accordance with various embodiments of the disclosure. FIG. 6A and FIG. 6B collectively is explained in conjunction with elements of FIG. 1, FIG. 2, FIG. 3A, FIG. 3B, FIG. 4, FIG. 5A, and FIG. 5B. With reference to FIG. 6A and FIG. 6B, there is shown a flowchart 600. The operations of the exemplary method may be executed by any computing system, for example, by the computer 102 of FIG. 1 or the system 202 of FIG. 2. The operations of the flowchart 600 may start at 602.

At 602, the first prompt 212A associated with the operational issue of the specific domain is received. The first prompt 212A includes the set of action specifications. In an embodiment, the system 202 is configured to receive the first prompt 212A associated with the operational issue of the specific domain. The first prompt 212A includes the set of action specifications. Details of the reception of the first prompt 212A are further described in conjunction with, for example, FIG. 3A.

At 604, the method data 210A associated with the first prompt 212A is retrieved. The method data 210A is retrieved from the knowledge base 210 based on the reception of the first prompt 212A. In an embodiment, the system 202 is configured to retrieve the method data 210A associated with the first prompt 212A. The method data 210A is retrieved from the knowledge base 210 based on the reception of the first prompt 212A. Details of the retrieval of the method data 210A associated with the first prompt 212A are further described in conjunction with, for example, FIG. 3A.

At 606, the set of action specifications is converted into a set of action specifications based on the retrieval of the method data 210A. In an embodiment, the system 202 is configured to convert the set of action specifications into the set of method signatures based on the retrieval of the method data. Details of the conversion of the set of action specifications into the set of method signatures based on the retrieval of the method data are further described in conjunction with, for example, FIG. 3A.

At 608, the set of method descriptions associated with the set of method signatures is retrieved based on the conversion. The method data includes the set of method descriptions. In an embodiment, the system 202 is configured to retrieve the set of method descriptions associated with the set of method signatures based on the conversion. The method data includes the set of method descriptions. Details of the retrieval of the set of method descriptions associated with the set of method signatures based on the conversion are further described in conjunction with, for example, FIG. 3A.

At 610, the second prompt 206 including the first prompt 212A, the set of method signatures, and the set of method descriptions is generated. The accuracy score of the second prompt 206 is greater than the accuracy score of the first prompt 212A. In an embodiment, the system 202 is configured to generate the second prompt 206 including the first prompt 212A, the set of method signatures, and the set of method descriptions. The accuracy score of the second prompt 206 is greater than the accuracy score of the first prompt 212A. Details of the generation of the second prompt 206 including the first prompt 212A, the set of method signatures, and the set of method descriptions are further described in conjunction with, for example, FIG. 3A.

At 612, the code language model 214 is applied to the second prompt 206. In an embodiment, the system 202 is configured to apply the code language model 214 to the second prompt 206. Details of the application of the code language model 214 to the second prompt 206 are further described in conjunction, with, for example, FIG. 3B.

At 614, the first set of executable instructions 204A for resolving the operational issue is generated. The first set of executable instructions 204A is generated based on the application of the code language model 214 to the second prompt 206. In an embodiment, the system 202 is configured to generate the first set of executable instructions 204A for resolving the operational issue. The first set of executable instructions 204A is generated based on the application of the code language model 214 to the second prompt 206. Details of the generation of the first set of executable instructions 204A for resolving the operational issue are further described in conjunction, with, for example, FIG. 3B.

At 616, the execution of at least the subset of executable instructions of the first set of executable instructions 204A is controlled. In an embodiment, the system 202 is configured to control the execution of at least the subset of executable instructions of the first set of executable instructions 204A. Details of the control of the execution of at least the subset of executable instructions of the first set of executable instructions 204A are further described in conjunction, with, for example, FIG. 3B.

At 618, the first output data is received based on the control of the execution of at least the subset of executable instructions of the first set of executable instructions 204A. In an embodiment, the system 202 is configured to receive the first output data based on the control of the execution of at least the subset of executable instructions of the first set of executable instructions 204A. Details of the reception of the first output data based on the control of the execution of at least the subset of executable instructions of the first set of executable instructions 204A are further described in conjunction, with, for example, FIG. 3B.

At 620, the second prompt 206 is modified based on the reception of the first output data. In an embodiment, the system 202 is configured to modify the second prompt 206 based on the reception of the first output data. Details of the modification of the second prompt 206 based on the reception of the first output data are further described in conjunction, with, for example, FIG. 3B.

At 622, the code language model 214 is applied to the modified second prompt. In an embodiment, the system 202 is configured to apply the code language model 214 to the modified second prompt. Details of the application of the code language model 214 to the modified second prompt are further described in conjunction, with, for example, FIG. 3B.

At 624, the second set of executable instructions 204B to resolve the operational issue is generated. The second set of executable instructions 204B is generated based on the application of the code language model 214 to the modified second prompt. In an embodiment, the system 202 is configured to generate the second set of executable instructions 204B to resolve the operational issue. The second set of executable instructions 204B is generated based on the application of the code language model 214 to the modified second prompt. Details of the generation of the second set of executable instructions 204B to resolve the operational issue are further described in conjunction, with, for example, FIG. 3B.

At 626, the execution of at least the subset of executable instructions of the second set of executable instructions 204B is controlled. In an embodiment, the system 202 is configured to control the execution of at least the subset of executable instructions of the second set of executable instructions 204B. Details of the control of the execution of at least the subset of executable instructions of the second set of executable instructions 204B are further described in conjunction, with, for example, FIG. 3B.

In various embodiments of the disclosure, a computer program-product for generation of executable instructions based on a code language model is described. The computer program product includes a computer-readable storage medium having program instructions stored on the computer-readable storage media to perform operations. The operations include receiving a first prompt associated with an operational issue of a specific domain. The operations further include retrieving method data associated with the first prompt. The method data is retrieved from a knowledge base based on the reception of the first prompt. The operations further include converting the set of action specifications into a set of method signatures based on the retrieval of the method data. The operations further include retrieving a set of method descriptions associated with the set of method signatures based on the conversion. The method data includes the set of method descriptions. The operations further include generating a second prompt including the first prompt, the set of method signatures, and the set of method descriptions. An accuracy score of the second prompt is greater than an accuracy score of the first prompt. The operations further include applying a code language model to the second prompt. The operations further include generating a set of executable instructions for a resolution of the operational issue. The first set of executable instructions is generated based on the application of the code language model to the second prompt. The operations further include controlling an execution of at least a subset of executable instructions of the first set of executable instructions.

The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable ordinary skill in the art to understand the embodiments disclosed herein.

What is claimed is

1. A computer-implemented method, comprising:
receiving, by a computer, a first prompt associated with an operational issue of a specific domain, wherein the first prompt comprises of a set of action specifications;
retrieving, by the computer, method data associated with the first prompt, wherein the method data is retrieved from a knowledge base based on the reception of the first prompt;
converting, by the computer, the set of action specifications into a set of method signatures based on the retrieval of the method data;
retrieving, by the computer, a set of method descriptions associated with the set of method signatures based on the conversion, wherein the method data comprises the set of method descriptions;
generating, by the computer, a second prompt comprising the first prompt, the set of method signatures, and the set of method descriptions, wherein an accuracy score of the second prompt is greater than an accuracy score of the first prompt;
applying, by the computer, a code language model to the second prompt;
generating, by the computer, a first set of executable instructions for a resolution of the operational issue, wherein the first set of executable instructions is generated based on the application of the code language model to the second prompt; and
controlling, by the computer, an execution of at least a subset of executable instructions of the first set of executable instructions.

2. The computer-implemented method of claim 1, further comprising:
receiving, by the computer, first output data based on the controlling of the execution of at least the subset of executable instructions; and
rendering, by the computer, the first output data.

3. The computer-implemented method of claim 2, further comprising:
receiving, by the computer, feedback data associated with the first output data and the first set of executable instructions, wherein the feedback data is received based on the controlling of the execution of at least the subset of executable instructions; and
modifying, by the computer, the second prompt based on the feedback data.

4. The computer-implemented method of claim 3, further comprising:
applying, by the computer, the code language model to the modified second prompt;
generating, by the computer, a second set of executable instructions for the resolution of the operational issue, wherein the second set of executable instructions is generated based on the application of the code language model to the modified second prompt; and
controlling, by the computer, the execution of at least a subset of executable instructions of the second set of executable instructions, wherein the execution of at least the subset of executable instructions of the second set of executable instructions resolves the operational issue of the specific domain.

5. The computer-implemented method of claim 4, further comprising:
receiving, by the computer, second output data based on the controlling of the execution of at least the subset of executable instructions of the second set of executable instructions; and
rendering, by the computer, the second output data.

6. The computer-implemented method of claim 1, further comprising:
analyzing, by the computer, the first prompt;
determining, by the computer, a programming language of a set of programming languages based on the analysis of the first prompt, wherein the first prompt comprises the programming language; and
generating, by the computer, the first set of executable instructions based on the determined programming language and the second prompt, wherein the first set of executable instructions is generated in the determined programming language.

7. The computer-implemented method of claim 6, wherein the knowledge base is associated with at least one programming language of the set of programming languages, or contextual data associated with the operational issue of the specific domain.

8. The computer-implemented method of claim 1, wherein the operational issue corresponds to a compliance problem, and wherein the compliance problem is associated with an adherence to at least one of regulatory guidelines, governmental regulations, or organization-specific regulations.

9. The computer-implemented method of claim 1, wherein each method description of the set of method descriptions is associated with a corresponding method signature of the set of method signatures, and wherein each method description is in a textual format.

10. A computer system, comprising:
a processor set;
one or more computer-readable storage media; and
program instructions stored on the one or more computer-readable storage media, the program instructions executable by the processor set to cause the processor set to:
receive a first prompt associated with an operational issue of a specific domain, wherein the first prompt comprises of a set of action specifications;
retrieve method data associated with the first prompt, wherein the method data is retrieved from a knowledge base based on the reception of the first prompt;
convert the set of action specifications into a set of method signatures based on the retrieval of the method data;
retrieve a set of method descriptions associated with the set of method signatures based on the conversion, wherein the method data comprises the set of method descriptions;
generate a second prompt comprising the first prompt, the set of method signatures, and the set of method descriptions, wherein an accuracy score of the second prompt is greater than an accuracy score of the first prompt;
apply a code language model to the second prompt;
generate a first set of executable instructions for a resolution of the operational issue, wherein the first set of executable instructions is generated based on the application of the code language model to the second prompt; and
control an execution of at least a subset of executable instructions of the first set of executable instructions.

11. The computer system of claim 10, wherein the program instructions further cause the processor set to:
receive first output data based on the control of the execution of at least the subset of executable instructions; and
render the first output data.

12. The computer system of claim 11, wherein the program instructions further cause the processor set to:
receive feedback data associated with the first output data and the first set of executable instructions, wherein the feedback data is received based on the control of the execution of at least the subset of executable instructions; and
modify the second prompt based on the feedback data.

13. The computer system of claim 10, wherein the program instructions further cause the processor set to:
analyze the first prompt;
determine a programming language of a set of programming languages based on the analysis of the first prompt, wherein the first prompt comprises the programming language; and
generate the first set of executable instructions based on the determined programming language and the second prompt, wherein the first set of executable instructions is generated in the determined programming language.

14. The computer system of claim 13, wherein the knowledge base is associated with at least one programming language of the set of programming languages, or contextual data associated with the operational issue of the specific domain.

15. The computer system of claim 10, wherein the operational issue corresponds to a compliance problem, and wherein the compliance problem is associated with an adherence to at least one of regulatory guidelines, governmental regulations, or organization-specific regulations.

16. The computer system of claim 10, wherein each method description of the set of method descriptions is associated with a corresponding method signature of the set of method signatures, and wherein each method description is in a textual format.

17. A computer-program product for a generation of executable instructions based on a code language model, the computer-program product comprising:
one or more computer-readable storage media; and
program instructions stored on the one or more computer-readable storage media to perform operations comprising:
receiving a first prompt associated with an operational issue of a specific domain, wherein the first prompt comprises of a set of action specifications;
retrieving method data associated with the first prompt, wherein the method data is retrieved from a knowledge base based on the reception of the first prompt;
converting the set of action specifications into a set of method signatures based on the retrieval of the method data;
retrieving a set of method descriptions associated with the set of method signatures based on the conversion, wherein the method data comprises the set of method descriptions;
generating a second prompt comprising the first prompt, the set of method signatures, and the set of method descriptions, wherein an accuracy score of the second prompt is greater than an accuracy score of the first prompt;
applying a code language model to the second prompt;
generating a first set of executable instructions for a resolution of the operational issue, wherein the first set of executable instructions is generated based on the application of the code language model to the second prompt; and
controlling an execution of at least a subset of executable instructions of the first set of executable instructions.

18. The computer-program product of claim 17, wherein the program instructions stored on the one or more computer-readable storage media perform the operations further comprising:
receiving first output data based on the controlling of the execution of at least the subset of executable instructions; and
rendering the first output data.

19. The computer-program product of claim 18, wherein the program instructions stored on the one or more computer-readable storage media perform the operations further comprising:
receiving feedback data associated with the first output data and the first set of executable instructions, wherein the feedback data is received based on the controlling of the execution of at least the subset of executable instructions; and
modifying the second prompt based on the feedback data.

20. The computer-program product of claim 17, wherein the program instructions stored on the one or more computer-readable storage media perform the operations further comprising:
analyzing the first prompt;
determining a programming language based on the analysis of the first prompt,
wherein the first prompt comprises the programming language; and
generating the first set of executable instructions based on the determined programming language and the second prompt, wherein the first set of executable instructions is generated in the determined programming language.
